(19) United States
(12) Patent Application Publication
(10) Pub. No.: US 2026/0061755 A1
(43) Pub. Date: Mar. 5, 2026

(54) Inkjet Recording Device

(71) Applicant: HITACHI INDUSTRIAL EQUIPMENT SYSTEMS CO., LTD,, Chiyoda-ku, Tokyo (JP)

(72) Inventors: Yu KANUMA, Tokyo (JP); Takahiro ARIMA, Tokyo (JP); Yusuke OKAMOTO, Tokyo (JP); Akira MYAO, Tokyo (JP)

(21) Appl. No.: 19/104,737

(22) PCT Filed: Sep. 22, 2022
(86) PCT No.: PCT/JP2022/035373

§ 371 Date: Feb. 19, 2025

(51) Int. Cl. B41J 2/185; B01F 33/45; B01F 35/22; B01F 101/35; B41J 2/035; B41J 2/175; B41J 2/20

(52) U.S. Cl. CPC B41J 2/185; B01F 33/45; B01F 35/2209; B41J 2/035; B41J 2/175; B41J 2/20; B01F 2101/35; B41J 2002/1853

(57) ABSTRACT

In an inkjet recording device that uses a pigment-based ink, an ink device is provided in which ink sticking in an ink path and the precipitation of pigment components in an ink container, which occur when printing is not performed over a long period, can be suppressed, and the pigment-based ink can be jetted in a short time at the restart of the printing. The inkjet recording device uses a pigment-based ink. A control section 7 executes a printing mode performing a printing operation and a rest mode not performing the printing operation. In the rest mode, the control section 7 forcibly performs the stirring of a pigment-based ink 68A in an ink container 31 and the circulation of the ink in an ink circulation path not including a printing head (S300) or the circulation of the ink in an ink circulation path including the printing head (S400). Accordingly, it is possible to suppress ink sticking in the ink circulation path and the precipitation of pigment components in an ink container, which occur when printing is not performed over a long period, and to jet the pigment-based ink in a short time at the restart of the printing.

### TECHNICAL FIELD

The present invention relates to an inkjet recording device. More specifically, the present invention relates to an inkjet recording device that uses a pigment-based ink.

### BACKGROUND ART

A typical continuous jet charge control type inkjet recording device is provided in its body with an ink container reserving an ink, and feeds the ink in the ink container to a printing head by an ink feeding pump. The ink fed to the printing head is continuously jetted from an ink nozzle, and is made into ink droplets. Of the ink droplets, the ink droplet used for printing is subjected to charging and deflection processes, and is made to fly to the desired printing position of a printing target to form a letter, and the ink droplet not used for the printing is not subjected to the charging and deflection processes, is collected by a gutter, and is returned to the ink container by an ink collection pump.

Such an inkjet recording device is disclosed in, for example, Japanese Unexamined Patent Application Publication No. 2021-14040 (Patent Literature 1)).

Patent Literature 1 discloses an inkjet recording device having a printing head receiving the feeding of an ink to perform printing, and a body including an ink container for accommodating the ink and a solvent container for accommodating a solvent and feeding the ink in the ink container to the printing head, the printing head being provided with a nozzle making the ink into an ink particle to discharge the ink particle, a charging electrode charging the ink particle discharged from the nozzle in response to a printing content, a deflection electrode changing the flying direction of the charged ink particle, and a gutter collecting the ink particle not contributing to the printing.

Further, the inkjet recording device is provided with a head cleaning unit including a cleaning tank for setting the printing head, a cleaning nozzle jetting the solvent toward the printing head set into the cleaning tank to clean the printing head, and a collection container provided in the bottom portion of the cleaning tank and collecting the solvent after cleaning, and a driving unit feeding the solvent to the cleaning nozzle.

In addition, as another inkjet recording device, for example, one described in Japanese Unexamined Patent Application Publication No. 2019-98658 (Patent Literature 2) is known.

Patent Literature 2 discloses an inkjet recording device provided with an ink container capable of storing a pigment-based ink for performing printing to a printing target, a nozzle connected to the ink container and discharging the ink, a charging electrode charging the ink discharged from the nozzle to be used for the printing, a deflection electrode deflecting the ink charged by the charging electrode, a stirring mechanism stirring the ink stored in the ink container, a stirring detection sensor provided in the ink container, and a control section judging whether the stirring detection sensor is conducted.

Further, the stirring detection sensor has two electrodes, a first electrode has a length so as to be immersed in the ink in the ink container, a second electrode is fixed in the state where the stirring mechanism is operated, and according to the case where the stirring mechanism stirs the ink or the case where the stirring mechanism does not stir the ink, the contact state is changed into the case where the first electrode and the second electrode are brought into contact with each other or the case where the first electrode and the second electrode are not brought into contact with each other.

### CITATION LIST

### Patent Literature

Patent Literature 1: Japanese Unexamined Patent Application Publication No. 2021-14040
Patent Literature 2: Japanese Unexamined Patent Application Publication No. 2019-98658

### SUMMARY OF INVENTION

### Technical Problem

In Patent Literature 1 described above, the inkjet recording device and the control that can prevent the ink sticking in the path by periodically circulating the ink in the state where the printing head is set to the head cleaning unit are described. However, Patent Literature 1 targets, as the ink, the dye ink, and does not give consideration regarding the pigment-based ink.

That is, in the inkjet recording device that uses the pigment-based ink, when the pigment-based ink is left without being stirred over the predetermined period, the pigment components contained in the pigment-based ink are precipitated to the bottom portion of the ink container in the ink container, which may inhibit the normal operation of the stirring body provided in the ink container. When the pigment-based ink is left without noticing such a state, the pigment-based ink cannot be stirred, and a difficulty can be caused in the normal feeding of the pigment-based ink.

In addition, in Patent Literature 2, the pigment components in the pigment-based ink are prevented from being precipitated into the ink container by rotating the stirring body of the stirring mechanism in the ink container during the jetting of the pigment-based ink performing the printing to stir the pigment-based ink while the pigment components are stirred up, and the stirring state is detected by the stirring detection sensor.

However, the stirring mechanism is operated only during the ink jetting that is executing the printing. Consequently, when the pigment-based ink is left without operating the inkjet recording device over a long time, the pigment-based ink may be stuck in the ink path, and the pigment components of the pigment-based ink may be precipitated into the ink container, so that the pigment-based ink cannot be fed at the restart of the printing, and the printing cannot be performed.

An object of the present invention is to provide an inkjet recording device that uses a pigment-based ink, the inkjet recording device in which ink sticking in an ink path and the precipitation of pigment components in an ink container, which occur when printing is not performed over a long period can be suppressed and the pigment-based ink can be jetted in a short time at the restart of the printing.

### Solution to Problem

In the present invention, an inkjet recording device is provided with: a printing head having a nozzle making a pigment-based ink to be fed into an ink particle to discharge the ink particle, a charging electrode charging the ink particle discharged from the nozzle, a deflection electrode deflecting the ink particle charged by the charging electrode, and a gutter collecting the unused ink not used for printing; an ink container reserving the pigment-based ink and provided with a stirring mechanism stirring the reserved pigment-based ink; a first ink circulation path including the printing head, feeding the pigment-based ink in the ink container to the printing head, and collecting the pigment-based ink into the ink container while circulating the pigment-based ink; a second ink circulation path not including the printing head, not feeding the pigment-based ink in the ink container to the printing head, and collecting the pigment-based ink into the ink container while circulating the pigment-based ink; and a control section controlling the operations of the printing head and the stirring mechanism. The control section executes a printing mode performing a printing operation and a rest mode not performing the printing operation. In the rest mode, the control section performs the stirring of the pigment-based ink in the ink container and the circulation of the ink in the first ink circulation path including the printing head or the circulation of the ink in the second ink circulation path not including the printing head.

### Advantageous Effects of Invention

According to the present invention, the inkjet recording device that uses the pigment-based ink has an operation and effect in which when the printing is not being performed, the stirring in the ink container and the ink circulation in the ink circulation path are forcibly performed, so that the ink sticking in the ink circulation path and the precipitation of the pigment components in the ink container, which occur when the printing is not performed over a long period can be suppressed, and the pigment-based ink can be jetted in a short time at the restart of the printing.

### BRIEF DESCRIPTION OF DRAWINGS

FIG. 1 is a diagram illustrating the using state of an inkjet recording device according to an embodiment of the present invention.

FIG. 2 is a diagram illustrating the path configurations of the inkjet recording device according to this embodiment.

FIG. 3 is a diagram illustrating the configuration of the control section of the inkjet recording device according to this embodiment.

FIG. 4 is a longitudinal sectional view illustrating the configuration of the ink container according to this embodiment.

FIG. 5 is a longitudinal sectional view illustrating the operation state of the stirrer of the ink container according to this embodiment.

FIG. 6A is a flowchart illustrating the control flow switching the rest mode and the printing mode according to this embodiment.

FIG. 6B is a flowchart illustrating the detailed control flow of the rest mode according to this embodiment.

FIG. 6C is a flowchart illustrating the detailed control flow of step S100 in FIG. 6B.

FIG. 6D is a flowchart illustrating the detailed control flow of step S200 in FIG. 6B.

FIG. 6E is a flowchart illustrating the detailed control flow of step S300 in FIG. 6B.

FIG. 6F is a flowchart illustrating the detailed control flow of step S400 in FIG. 6B.

FIG. 7 is an explanatory view explaining the flow of the ink and the air when the ink circulation is performed in the ink path and the ink circulation is performed in the printing head according to this embodiment.

FIG. 8 is an explanatory view explaining the flow of the ink and the air when the ink circulation is performed in the ink path according to this embodiment.

FIG. 9 is an explanatory view explaining the display screen at the ink circulation in the ink path and at the ink circulation in the printing head according to this embodiment.

FIG. 10 is an explanatory view explaining the display screen at the ink circulation in the ink path according to this embodiment.

FIG. 11 is an explanatory view explaining the valid/invalid selection screen of the periodic ink circulation process according to this embodiment.

### DESCRIPTION OF EMBODIMENTS

Hereinbelow, an embodiment of the present invention will be described in detail with reference to the drawings, but the present invention is not limited to the following embodiment, and also includes various modification examples and application examples in the range of the technical concept of the present invention. The present invention is not limited to the embodiment described below. In addition, in the following respective drawings, the same devices are indicated by the same numbers (reference numerals), and the description of the already described components may be omitted.

### [the Description of the Overall Configuration of an Inkjet Recording Device]

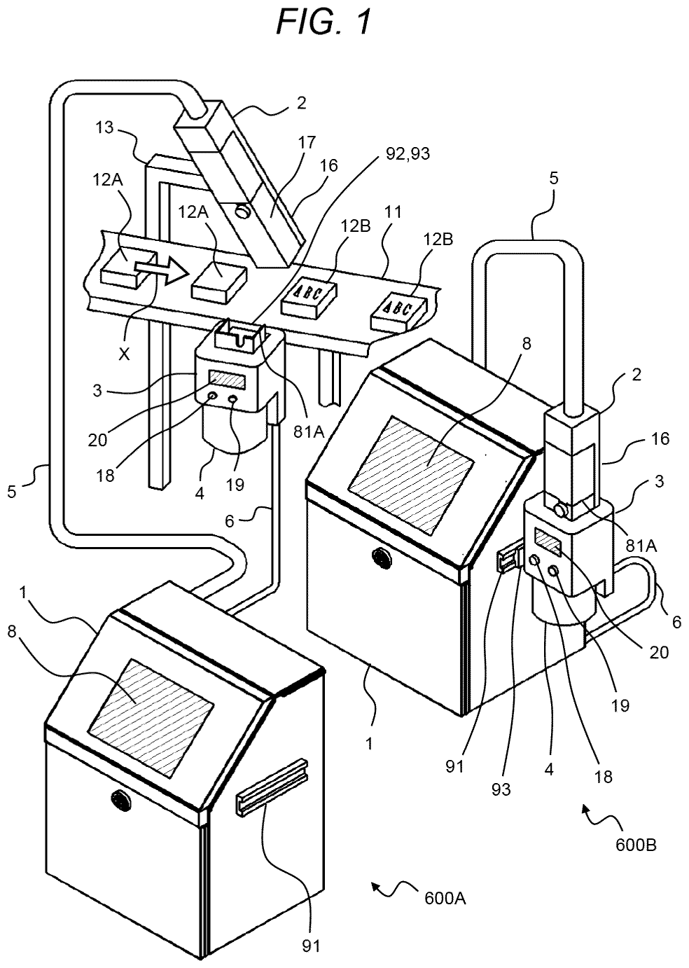

First, the using state of an inkjet recording device according to the embodiment of the present invention will be described with reference to FIG. 1. FIG. 1 illustrates the using state of the inkjet recording device according to the embodiment of the present invention.

In FIG. 1, each of an inkjet recording device 600A and an inkjet recording device 600B installed in a manufacturing factory is provided with a body 1, a printing head 2 connected with the body 1 by a cable (for printing head) 5, and a head mounting unit 3 connected with the body 1 by a cable (for head mounting unit) 6.

Here, although the head mounting unit 3 basically has a function of accommodating the printing head 2, the head mounting unit 3 may be added with a function of jetting a cleaning liquid to clean the printing head. The head mounting unit 3 described below is added with the function of cleaning the printing head.

In the inkjet recording device 600A, a state where the printing head 2 is installed to a production line is illustrated. In addition, in the inkjet recording device 600B, a state where the printing head 2 is removed from the production line, and is mounted (set) to the head mounting unit 3 is illustrated. It should be noted that a collection container 4 mounted to the lower portion of the head mounting unit 3 is provided for accommodating the liquid (cleaning liquid) after the cleaning of the printing head by the head mounting unit 3.

For example, the inkjet recording device 600A is installed to the production line in the factory in which food, a beverage, and the like are produced, and the body 1 is installed in a place in which a space necessary for a periodic maintenance operation and the like can be secured. The printing head 2 is fixed to a printing head fixing fixture 13 installed in the vicinity of a belt conveyor 11, and is installed to be close to printing targets 12A and 12B for printing to the printing targets 12A and 12B fed on the production line such as the belt conveyor 11 in the direction of the arrow X.

In addition, to the printing head 2, a protective cover 17 is mounted for the purpose of protecting the part inside the printing head 2. It should be noted that the printing target 12B is illustrated in the state where the printing by the printing head 2 is ended and the printing target 12B is conveyed on the belt conveyor 11.

It should be noted that in FIG. 1, the body 1 accommodates (holds) a printing ink, and controls a driving section (a pump and an solenoid valve) inside the body to feed the ink through the cable (for printing head) 5 to the printing head 2. It should be noted that the details of the inner path configuration and the control section of the body 1 will be described later.

An operation display section 8 is installed in the upper surface portion of the body 1, and here, a touch input type display panel is used. The operator touch operates the operation display section 8, so that with respect to the control section, the start and stop of the device can be instructed and a content printed to the printing target 12A can be set. In addition, in FIG. 1, the printing head 2 is provided with a head base 16 and the protective cover 17.

The head mounting unit 3 is installed around the printing head 2. The head mounting unit 3 in the inkjet recording device 600A is fixed by combining a fixing jig 92 assembled to the belt conveyor 11 with a fitting section 93 assembled to the head mounting unit 3.

Then, the head mounting unit 3 has a head mounting section 81A for mounting the printing head 2 to the head mounting unit. Further, the head mounting unit 3 has a start button 18 for starting the cleaning process for the printing head 2, a stop button 19 for stopping the cleaning process for the printing head 2, and a display section 20 which allows the operator to recognize a confirmation message, a warning, and an alarm such as an abnormality.

The display section 20 may cause the operator to recognize the operation state and the presence or absence of an abnormality according to, for example, the light presence or absence and the difference in color of a light.

In the inkjet recording device 600A of this embodiment, the head mounting unit 3 is fixed in the vicinity of the belt conveyor 11, but the head mounting unit 3 can be freely replaced to a place where the head mounting unit 3 can be easily operated by the user. It should be noted that the length of the cable (for head mounting unit) 6 connecting the body 1 and the head mounting unit 3 is preferably the same as or longer than the cable 5 connecting the body 1 of the inkjet recording device 600 and the printing head 2. This is for securing the degree of freedom of the arrangement of the head mounting unit.

In addition, the body 1 has a fixing section 91 for fixing the head mounting unit 3, and the head mounting unit 3 can also be used in such a manner that the head mounting unit is removed from the fixing jig (for conveyor) 92 and is attached to the fixing section 91.

In the using state of the inkjet recording device 600B, the head mounting unit 3 can also be fixed to the body 1 by combining the fixing section 91 assembled to the body 1 with the fitting section 93. The head mounting unit 3 of the inkjet recording device 600B is mounted to the body 1. The head mounting unit 3 can be made to be fixed to the body 1, so that even when there is no space for mounting the head mounting unit 3, for example, in the vicinity of the belt conveyor 11, the head mounting unit 3 can be installed.

Next, the state where in the inkjet recording device 600B, the printing head 2 is set to the head mounting unit 3 will be described. The printing head 2 is set by being mounted to the head mounting section 81A of the head mounting unit 3 from the end of the printing head 2. In the inkjet recording device 600 according to this embodiment, the printing head 2 is set to the head mounting unit in this way, so that the printing head 2 can be cleaned by a solvent 69A fed from the body 1 side through the cable (for head mounting unit) 6.

### [the Description of an Ink Circulation Path]

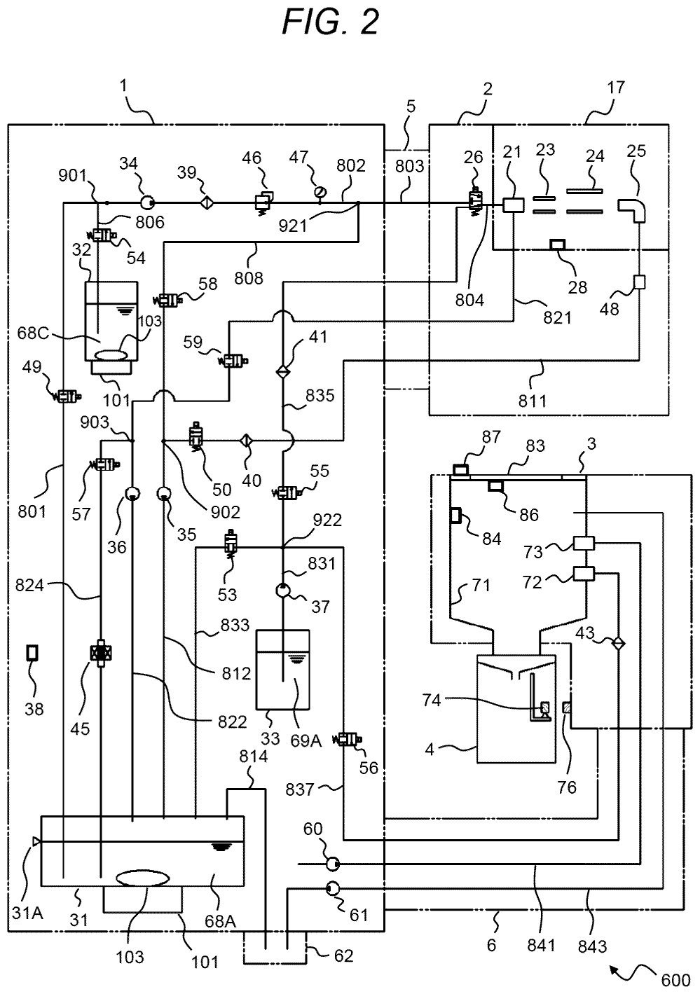

Next, the configuration of the ink circulation path of the inkjet recording device 600 according to this embodiment will be described with reference to FIG. 2. It should be noted that hereinbelow, the ink circulation path may also be denoted as an ink path, and in this case, the ink path is read as the ink circulation path.

In addition, also when the path in which the ink flows is indicated by an individual name for description, the path in which the ink flows is handled as one configuring part of the ink circulation path. In brief, the path in which the ink flows is in the category of the ink circulation path.

FIG. 2 illustrates the configurations of the entire ink path of the inkjet recording device 600 according to this embodiment. First, the ink paths (paths 801 to 804) of the inkjet recording device 600 according to this embodiment will be described.

In FIG. 2, the body 1 is provided with a main ink container 31 reserving a pigment-based ink 68A to be circulated and an auxiliary ink container 32 reserving a pigment-based ink 68C. Here, since the auxiliary ink container 32 adopts the same configuration as the main ink container 31, the description about the stirring of the pigment-based ink 68C is omitted.

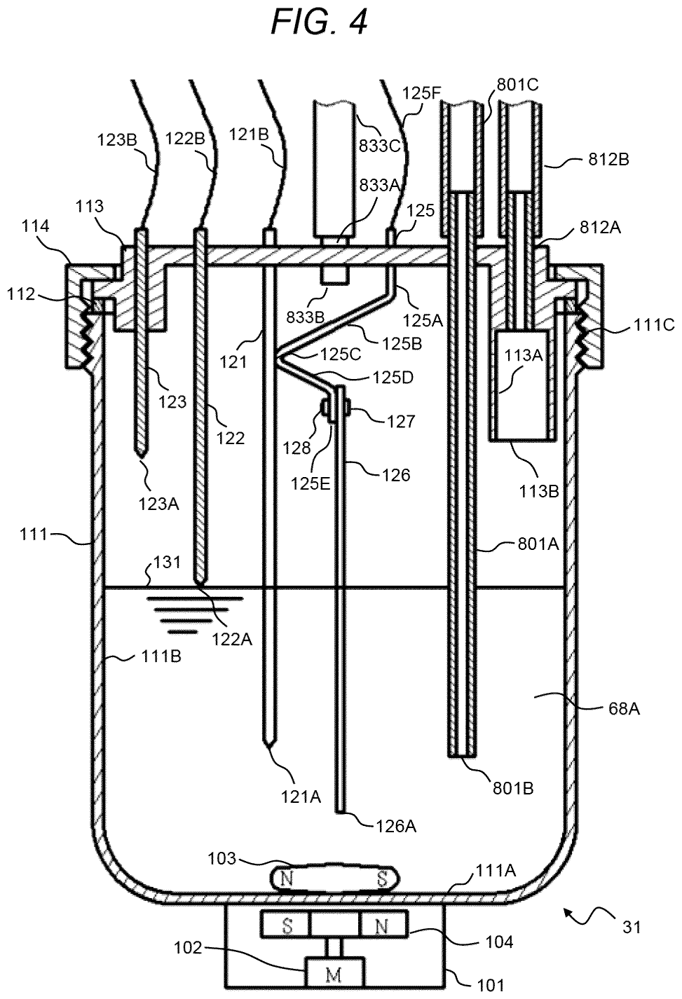

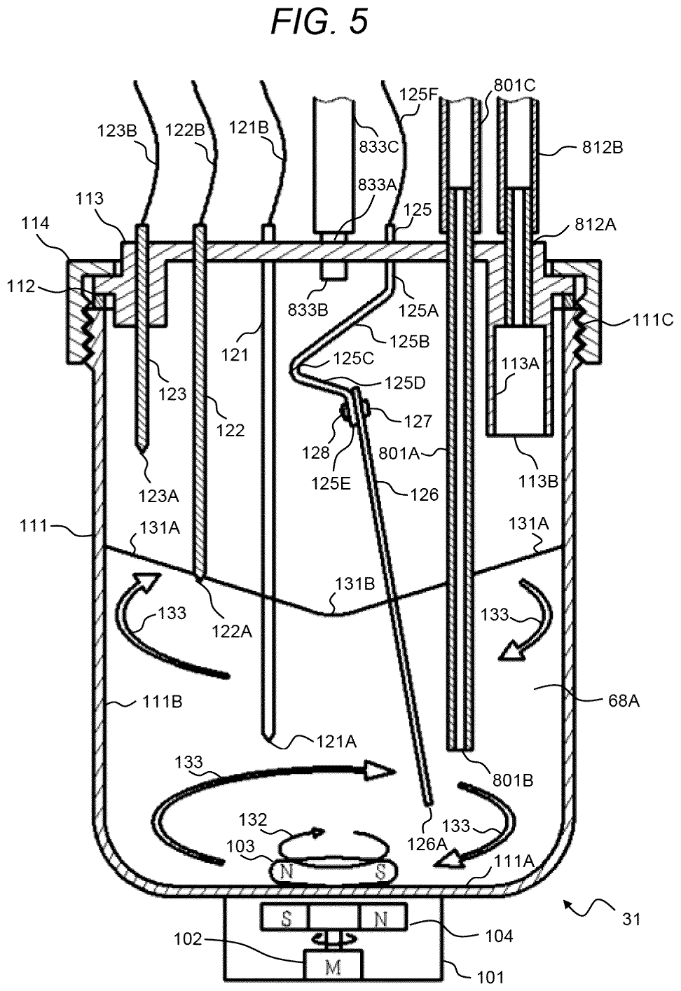

As illustrated in FIGS. 4 and 5, in the lower portion of the main ink container 31, a stirrer 101 and a motor 102 for operating the stirrer 101 are installed. In addition, in the main ink container 31, a stirring body 103 rotated in conjunction with a rotor 104 of the stirrer 101 is stored. The rotation of the stirring body 103 prevents the pigment components of the pigment-based ink 68A in the main ink container 31 from being precipitated to the bottom portion of the main ink container 31. The operation of the stirrer 101 and the stirring body 103 will be described in more detail with reference to FIGS. 4 and 5.

A temperature sensor 38 is assembled to the body 1, and is connected with a control section 7 installed in the body 1. In addition, the main ink container 31 is provided with a liquid surface level sensor 31A detecting whether or not the liquid (the pigment-based ink 68A) in the main ink container 31 has reached a reference liquid surface level that is an amount proper to be held inside.

The main ink container 31 is connected to the ink path (for feeding) 801 in the portion immersed in the pigment-based ink 68A, and midway through the ink path 801, an solenoid valve (for feeding) 49 opening and closing the ink path 801 is installed.

Further, the ink path 801 is connected through a joining path 901 to a pump (for feeding) 34 installed in the ink path 802 and used for suctioning and pumping the pigment-based ink 68A. Then, the output side of the pump (for feeding) 34 is connected to a filter (for feeding) 39 removing a foreign substance mixed into the pigment-based ink 68A.

The filter (for feeding) 39 is connected to a pressure regulation valve 46 performing regulation to a proper pressure for printing the pigment-based ink 68A pumped from the pump (for feeding) 34, and the pressure regulation valve 46 is connected to a pressure sensor 47 measuring the pressure of the pigment-based ink 68A fed to a nozzle 21.

The ink path 802 in which the pressure sensor 47 is arranged is connected through a branching path 921 to the ink path 803 passing in the cable (for printing head) 5, and the ink path 803 is connected to a switching valve 26 provided in the printing head 2 and for controlling whether the pigment-based ink 68A is fed to the nozzle 21.

The switching valve 26 is connected through the ink path 804 to the nozzle 21 provided with a discharge port 21A discharging the pigment-based ink 68A. It should be noted that the switching valve 26 is a three-way solenoid valve, and the switching valve 26 is connected with the ink path 802 for the ink feeding and an ink path 835 for the nozzle cleaning, and can perform switching of feeding between the pigment-based ink 68A and the solvent 69A with respect to the nozzle 21.

In the straight traveling direction of the discharge port 21A of the nozzle 21, arranged are a charging electrode 23 for adding a predetermined charging amount to an ink particle 68B, a deflection electrode 24 for deflecting the ink particle 68B used for the printing, and a gutter 25 for capturing the ink particle which flies in the straight traveling manner without being charged and deflected so as not to be used for the printing.

Next, ink collection paths 811 and 812 of the inkjet recording device 600 will be described.

In FIG. 2, the gutter 25 is connected to the ink path 811, and in the ink path 811, a charging sensor (auto phase sensor) 48 for detecting whether the ink particle to which the charging amount is added by the charging electrode 23 is collected is arranged. Then, the ink path 811 passes in the cable (for printing head) 5, and is connected to a filter (for collection) 40 arranged in the body 1 and removing a foreign substance mixed into the ink, and the filter (for collection) 40 is connected to an solenoid valve (for collection) 50 opening and closing the ink path.

The solenoid valve (for collection) 50 is connected to a pump (for collection) 35 arranged in the ink path 812 connected through a joining path 902 and suctioning the ink particle captured by the gutter 25. The pump (for collection) is connected with the main ink container 31. The solenoid valve 50 is opened to drive the pump 35, so that the ink particle captured by the gutter 25 is collected into the ink container 31.

Next, an exhaust path 814 of the inkjet recording device 600 according to this embodiment will be described.

The ink container 31 is connected with the exhaust path 814 in the space of the upper portion being in not contact with the pigment-based ink 68A, and the exhaust path 814 is connected to an exhaust duct connection section 62 communicated with the outside of the body 1.

Next, the ink paths (paths 821 and 822) of the inkjet recording device 600 according to this embodiment will be described.

The nozzle 21 provided in the printing head 2 is connected to the ink path 821 passing in the cable (for printing head) 5, in addition to the ink path 804 for the ink feeding. In the ink path 821, an solenoid valve (for circulation) 59 provided in the body 1 and opening and closing the flow passage is arranged.

The solenoid valve (for circulation) 59 is connected through a joining path 903 to the ink path 822, and in the ink path 822, a pump (for circulation) 36 suctioning the ink from the nozzle 21 is arranged. Then, the pump (for circulation) 36 is connected to the main ink container 31. Next, viscosity measurement paths (824 and 822) of the inkjet recording device 600 according to this embodiment will be described.

In FIG. 2, the main ink container 31 is connected to the ink path (for viscosity measurement) 824 in the portion immersed in the pigment-based ink 68A. The ink path (for viscosity measurement) 824 is connected to a viscosity measurement device 45 to grasp the viscosity of the pigment-based ink 68A in the main ink container 31. The viscosity measurement device 45 is connected to an solenoid valve (for viscosity measurement) 57 opening and closing the ink path.

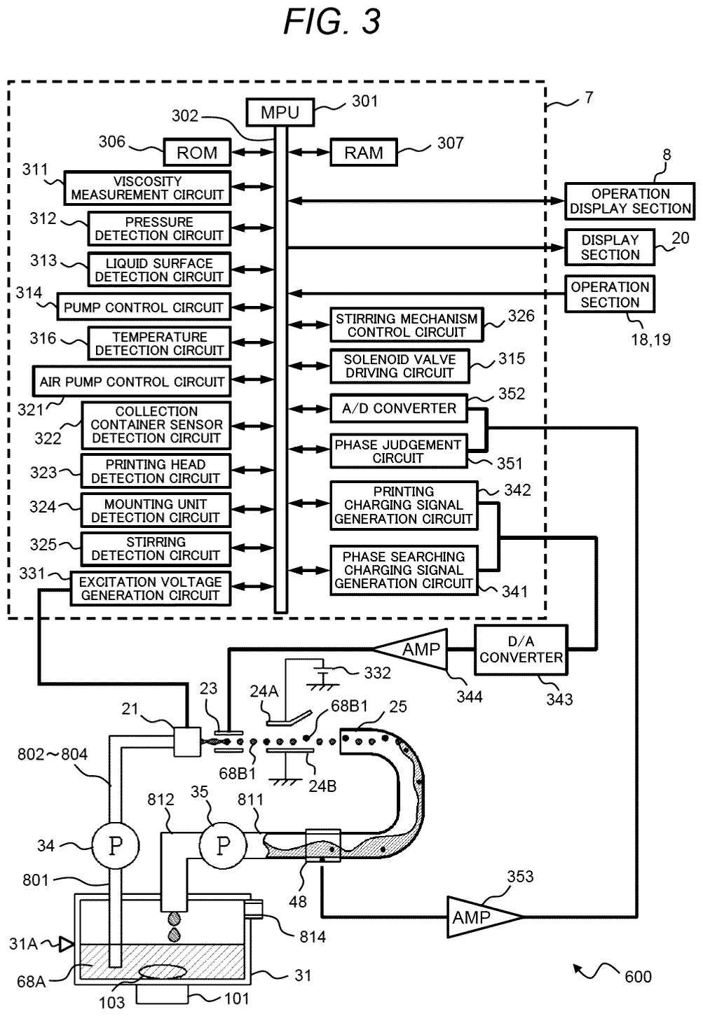

The solenoid valve (for viscosity measurement) 57 is connected through the joining path 903 with the pump (for circulation) 36 arranged in the ink path 822. With this, the pigment-based ink 68A in the ink container 31 can be circulated in the viscosity measurement path, so that the viscosity of the pigment-based ink 68A can be measured. The viscosity measured in this way is inputted to the control section 7 (not illustrated in FIG. 2, and see FIG. 3), and is used for the viscosity control of the pigment-based ink 68A of the ink container 31.

Next, the solvent replenishment paths (paths 831 and 833) of the inkjet recording device 600 according to this embodiment will be described.

In FIG. 2, the body 1 is provided with a solvent container 33 holding the solvent 69A to be used for the solvent replenishment to the main ink container 31, the nozzle cleaning, or the head cleaning. The solvent container 33 is connected to the solvent replenishment path 831 in the portion immersed in the solvent 69A, and in the solvent replenishment path 831, a pump (for solvent) 37 used to suction and pump the solvent is arranged.

Then, the pump (for solvent) 37 is connected to a branching path 922 to change the feeding destination of the solvent 69A according to the purpose. In the solvent replenishment path 831, the branching path 922 is connected to an solenoid valve (for solvent replenishment) 53 arranged in the solvent replenishment path 833 and for opening and closing the flow passage, and the solenoid valve (for solvent replenishment) 53 is connected to the main ink container 31. The solvent replenishment path 831 is used to perform the viscosity control of the pigment-based ink 68A in the ink container 31 by the control of the control section 7.

Next, an ink replenishment path 806 of the inkjet recording device 600 according to this embodiment will be described.

In FIG. 2, the body 1 is provided with the auxiliary ink container 32 holding the ink 68C for the replenishment. The auxiliary ink container 32 is connected to the ink replenishment path 806 in the portion immersed in the ink 68C. The ink replenishment path 806 is connected to an solenoid valve (for ink replenishment) 54 opening and closing the ink replenishment path 806, and the solenoid valve (for ink replenishment) 54 is connected through the joining path 901 to the pump (for feeding) 34 installed in the path 801 and used to suction and pump the ink 68C.

Then, the ink 68C in the auxiliary ink container 32 is replenished to the main ink container 31 through the nozzle 21 and through the gutter 25, the ink path 811, the solenoid valve 50, and the pump 35.

Next, the nozzle cleaning paths (the paths 831 and 835) of the inkjet recording device 600 according to this embodiment will be described.

In FIG. 2, the pump (for solvent) 37 arranged in the nozzle cleaning path 831 is connected through the branching path 922 to the nozzle cleaning path 835. The nozzle cleaning path 835 is connected to an solenoid valve (for nozzle cleaning) 55 for opening and closing the flow passage. Then, the solenoid valve (for nozzle cleaning) 55 is connected to a filter (for nozzle cleaning) 41 for removing a foreign substance mixed into the solvent 69A.

The filter (for nozzle cleaning) 41 is connected to the switching valve 26 provided in the printing head 2 through the ink path 821 passing in the cable (for printing head) 5 and for controlling whether the solvent 69A for cleaning is sent to the nozzle 21.

Next, the body circulation paths (paths 808 and 812) of the inkjet recording device 600 according to this embodiment will be described.

The ink path 802 is connected through the branching path 921 to the body circulation path 808. The body circulation path 808 is connected to an solenoid valve (for body circulation) 58 opening and closing the path, and the solenoid valve (for body circulation) 58 is connected through the joining path 902 to the pump (for collection) 35 installed in the body circulation path 812.

Next, the head cleaning paths (paths 831 and 837) of the inkjet recording device 600 according to this embodiment will be described.

In FIG. 2, the pump (for solvent) 37 is connected through the branching path 922 to the head cleaning path 837, an solenoid valve (for head cleaning) 56 for opening and closing the flow passage is arranged in the head cleaning path 837, and the solenoid valve (for head cleaning) 56 is connected to a filter (for head cleaning) 43 which removes a foreign substance mixed into the solvent 69A.

Then, the output side of the filter (for head cleaning) 43 is connected to a cleaning nozzle 72 provided inside a cleaning tank 71 of the head mounting unit 3. Here, the space inside the cleaning tank 71 is communicated with the collection container 4 installed in the lower portion. The collection container 4 is provided to store the solvent after being cleaned by the cleaning liquid (solvent) jetted from the cleaning nozzle 72 grounded inside the cleaning tank 71.

In the collection container 4, a float 74 is provided to detect the liquid level of the solvent after cleaning. When the float 74 incorporating a magnet has reached a predetermined liquid level, a magnetic sensor A76 detects the liquid level, and outputs, to the control section (not illustrated in FIG. 2), that the cleaning liquid in the collection container 4 has reached the predetermined liquid level.

Next, the air feeding path (path 841) of the inkjet recording device 600 according to this embodiment will be described.

In FIG. 2, the body 1 is provided with a pump (for drying) 60 used to suction and pump air, and the pump (for drying) 60 is formed with an air suction port communicated with the inside of the body 1. The pump (for drying) 60 is connected to an air feeding nozzle 73 provided inside the cleaning tank 71 of the head mounting unit 3 through the air feeding path 841 passing in the cable (for head mounting unit) 6.

Next, the air suctioning path (path 843) of the inkjet recording device 600 according to this embodiment will be described.

The cleaning tank 71 provided in the head mounting unit 3 is connected through the air suctioning path 843 passing in the cable (for head mounting unit) 6 to an air pump (for suctioning) 61 provided in the body 1 and used to suction and pump air. Then, the pump (for suctioning) 61 is connected to the exhaust duct connection section 62 communicated with the outside of the body 1.

### [the Description of the Control Section]

Next, the configuration of the control section 7 of the inkjet recording device 600 according to this embodiment will be described.

FIG. 3 illustrates the schematic configuration of the control section 7 and the printing mechanism section (the body 1 and the printing head 2) of the inkjet recording device 600 according to this embodiment.

In FIG. 3, the inkjet recording device 600 is provided with a microprocessing unit (hereinafter, called an MPU) 301 that is the control section controlling the entire inkjet recording device 600. In addition, the inkjet recording device 600 is provided with a bus line 302 to have a function of transmitting data, a control signal, and the like between the respective devices configuring the control section. For example, the bus line 302 is used to input data, a detection signal, and the like necessary for the calculation of the MPU 301 from each device and to transmit a data signal, an address signal, and a control signal to each device.

A controlling program and data necessary for operating the MPU 301 are stored in a read only memory (ROM) 306. In addition, data which is necessary during the program execution for the MPU 301 is temporarily stored in a rewritable memory (RAM) 307.

The inputting of a printing content, a set value, and the like and the display of the inputted data, the printing content, and the like are performed by the operation display section 8. Here, the operation display section 8 uses a touch input type display panel in which a transparent touch switch is overlapped with the surface of the liquid crystal display screen.

In addition, the head mounting unit 3 can be controlled from the operation display section 8 of the control section 7, but the operation section (the start button 18 and the stop button 19) is used when the driving operation regarding the head mounting unit 3 is operated near the head mounting unit 3, not on the operation display section 8. Then, the display section 20 is used when driving state confirmation, an abnormality message, and the like regarding the head mounting unit 3 are confirmed near the head mounting unit 3, not on the operation display section 8.

The printing head 2 of the inkjet recording device 600 is provided with the nozzle 21 making the pigment-based ink 68A pressurized and fed from the main ink container 31 into the ink particle, and discharging the ink particle. The nozzle 21 jets the ink in columnar shape, and the end of the ink is separated to be discharged as the ink particle 68B. In addition, the printing head 2 is provided with the charging electrode 23 so as to surround the ink particle 68B, and charges the ink particle 68B according to the printing content.

Further, the printing head 2 deflects the ink particle 68B charged by the charging electrode 23 and flying according to the charging amount, and flies the ink particle 68B toward the object to be printed (not illustrated). Then, the flied ink particle is landed onto the object to be printed to execute the printing. The deflection electrode 24 of the printing head 2 is configured of a ground electrode 24B and a plus electrode 24A.

In addition, the printing head 2 is provided with the gutter 25 capturing the ink particle 68B (unused ink) that has not been used for the printing, and the charging sensor 48 generating a phase detection signal according to the charging amount of an ink particle 68B1 that is finely charged, among the ink particles 68B captured by the gutter 25.

In addition, on the body 1 side, the pump (for collection) 35 collecting the ink (ink particle) captured by the gutter 25 into the ink container 31, and the ink collection paths 811 and 812 connecting the gutter 25 and the ink container 31 are provided.

Then, the control section 7 has an excitation voltage generation circuit 331 exciting an electrostriction element 22 (not illustrated) incorporated in the nozzle 21 in order to cause the timing for separation from the ink column jetted from the nozzle 21 into the ink particle 68B to have regularity.

In addition, the control section 7 has a printing charging signal generation circuit 342 and a phase searching charging signal generation circuit 341, a D/A converter 343 converting a charging signal in digital signal form outputted from them to a voltage signal in analog form, and an amplification circuit 344 amplifying the voltage signal in analog signal form outputted from the D/A converter 343 to generate a charging voltage applied to the charging electrode 23.

It should be noted that in place of the configuration provided with the printing charging signal generation circuit 342 and the phase searching charging signal generation circuit 341, the inkjet recording device 600 may be achieved by the charging amount control by the control section by using only the printing charging signal generation circuit 342. In addition, the inkjet recording device 600 is provided with a deflection voltage generation circuit 332 generating a deflection voltage applied to the deflection electrode 24.

In addition, the inkjet recording device 600 is provided with an amplification circuit 353 amplifying the phase detection signal in analog signal form outputted from the charging sensor 48, a phase judgement circuit 351 inputting the amplified phase detection signal to judge whether or not charging is good, and an A/D converter 352 inputting the amplified phase detection signal to perform A/D conversion.

In FIG. 3, the MPU 301 of the control section 7 is connected through the bus line 302 to a liquid surface detection circuit 313 for managing the liquid surface of the main ink container 31, a pressure detection circuit 312 for detecting whether the pressure of the ink fed to the nozzle 21 is a proper value, a viscosity measurement circuit 311 for measuring, by the viscosity measurement device 45, whether the viscosity of the pigment-based ink 68A fed to the nozzle 21 is a proper value for the printing, a temperature detection circuit 316 for measuring, by the temperature sensor 38, whether the temperature in the body 1 is a proper value, a pump control circuit 314 for controlling the respective pumps 34 to 37 equipped in the body 1 and suctioning and pumping the pigment-based ink 68A and the solvent 69A, and an solenoid valve driving circuit 315 for controlling the opening and closing operation of the respective solenoid valves 49 and 50 and 53 to 59 in the respective paths, and controls the respective portions.

In addition, the MPU 301 is connected through the bus line 302 to an air pump control circuit 321 for controlling the pump 60 and the pump 61, a collection container sensor detection circuit 322 for using the magnetic sensor A 76 and a magnet A 75 to detect that the collection container 4 is mounted to the head mounting unit 3 and that the liquid (not illustrated) in the collection container 4 is not larger than a predetermined amount, a printing head detection circuit 323 for using a magnetic sensor B 84 and a magnet B 86 to detect, on the head mounting unit 3 side, that the printing head 2 is mounted to the head mounting unit 3, and a head mounting unit detection circuit 324 for using a magnetic sensor C 28 and a magnet C 87 to detect, on the printing head 2 side, that the printing head 2 is mounted to the head mounting unit 3, and controls the respective portions.

In addition, in FIG. 3, the MPU 301 of the control section 7 is provided through the bus line 302 with a stirring mechanism control circuit 326 for controlling the stirrer 101 and the stirring body 103 equipped to stir the pigment-based ink 68A in the main ink container 31 and a stirring detection circuit 325 for detecting whether the pigment-based ink 68A in the main ink container 31 is stirred.

It should be noted that for the control section 7, a calculator can be used. Specifically, the control section 7 can be configured of the MPU 301, the memory (306 and 307) storing a program for the operation of the MPU 301 and data and information necessary for the operation, and the driving section operating the printing head 2, the head mounting unit 3, and the configuration device in the body 1 by the instruction of the MPU 301. Here, the detailed description of the control section 7 is omitted.

### [the Description of the Main Ink Container]

The configuration of the main ink container 31 according to this embodiment will be described with reference to FIG. 4. FIG. 4 illustrates the longitudinal section of the main ink container 31 according to this embodiment.

As illustrated in FIG. 4, the stirrer 101 is installed in the lower portion of the main ink container 31, and the stirrer 101 is configured of the magnetic rotor 104 configured of a magnetic body, and the motor 102 for driving the magnetic rotor 104.

Then, the main ink container 31 is provided with a liquid reservation section 111 for storing the pigment-based ink 68A therein. The liquid reservation section 111 is provided with a container bottom surface 111A in circular shape to easily stir the pigment-based ink 68A, a container side surface 111B connected with the container bottom surface 111A in gentle R shape, and a connection section 111C positioned in the upper portion of the container side surface 111B and arranged at the higher position than an ink reference liquid surface 131 of the pigment-based ink 68A.

In the container bottom surface 111A of such the liquid reservation section 111, the stirring body 103 rotated in conjunction with the magnetic rotor 104 of the stirrer 101 is installed. The stirrer 101 and the stirring body 103 are called a stirring mechanism. For the magnetic rotor 104 and the stirring body 103, a permanent magnet and the like can be used as the magnetic body. Upon the reception of the magnetic field of this magnet, the stirring body 103 formed of the magnet is also rotated in conjunction therewith, a convection is caused in the ink, and the pigment-based ink 68A in the main ink container 31 is stirred.

In the upper portion of the liquid reservation section 111, a connection block 113 generated of a resin material that is an insulator is provided, and between the liquid reservation section 111 and the connection block 113, a seal member 112 generated of a resilient material such as rubber so as to hold airtightness is provided. Then, the connection block 113 is fixed to the liquid reservation section 111 by a fixing lid 114 so as to be mounted by being fitted to the screw portion of the connection section 111C of the liquid reservation section 111.

The connection block 113 is provided with an electrode (GND) 121, an electrode (reference) 122, and an electrode (abnormality detection) 123. An end portion 121A of the electrode (GND) 121 is located in the lower portion than the ink reference liquid surface 131, and is immersed in the pigment-based ink 68A held by the liquid reservation section 111. An end portion 122A of the electrode (reference) 122 is positioned at the same height as the ink reference liquid surface 131.

An end portion 123A of the electrode (abnormality detection) 123 is positioned in the upper portion than the ink reference liquid surface 131 and in the lower portion than the seal member 112. Each of these electrode (GND) 121, electrode (reference) 122, and electrode (abnormality detection) 123 is generated by processing a round rod of a conductive stainless material, and is assembled to the connection block 113 by, for example, press fit.

Then, on the outside of the liquid reservation section 111, the electrode (GND) 121 is connected with an electrode (GND) electric wire 121B, the electrode (reference) 122 is connected with an electrode (reference) electric wire 122B, and the electrode (abnormality detection) 123 is connected with an electrode (abnormality detection) electric wire 123B. By the instruction from the control section 7, the electrode (GND) 121, the electrode (reference) 122, and the electrode (abnormality detection) 123 can receive or transmit an electric signal.

The circuit having a power supply flowing the electric signal to the electrode (GND) 121, a stirring detection sensor electrode 125, and the like may be provided in the control section 7, and may be provided to be separated from the control section 7. By the instruction from the control section 7, the electric signal is made to flow to the selected electrode to detect the presence or absence of conduction, and it can be judged, by the control section 7, whether the electrodes are conducted with each other.

The pigment-based ink 68A stored in the liquid reservation section 111 is made to contain a conductive material in the material composition. With that, for example, when the electrode (reference) end portion 122A is brought into contact with the pigment-based ink 68A, the electrode (reference) 122 and the electrode (GND) 121 are brought into the state of being electrically conducted, and when the electrode (reference) 122 and the electrode (GND) 121 are electrically conducted by the electric signal from the control section 7, the control section 7 can judge that the liquid surface of the pigment-based ink 68A is the same as or higher than the ink reference liquid surface 131.

In addition, when the electrode (reference) 122 and the electrode (GND) 121 are not electrically conducted, it can be judged that the liquid surface of the pigment-based ink 68A is lower than the ink reference liquid surface 131. Then, further, when the electrode (abnormality detection) 123 and the electrode (GND) 121 are electrically conducted, a large amount of liquid flows into the liquid reservation section 111 due to some abnormality, thereby exhibiting that the liquid surface of the pigment-based ink 68A is abnormally increased, and the control section 7 judges that this is an abnormal state.

The connection block 113 is provided with the stirring detection sensor electrode 125 made of a conductive stainless material in thin plate shape. The stirring detection sensor electrode 125 has a sensor electrode flat portion 125A, a sensor electrode tilting portion 125B, a sensor electrode contact point portion 125C, a sensor electrode tilting portion 125D, and a sensor electrode lower end portion 125E.

The sensor electrode flat portion 125A is formed to be assembled to the connection block 113 by a method such as press fit. The sensor electrode tilting portion 125B extends from the sensor electrode flat portion 125A toward the electrode (GND) 121 in the downward oblique direction.

The sensor electrode contact point portion 125C is in contact with the electrode (GND) 121 when the stirrer 101 is stopped.

The sensor electrode tilting portion 125D extends from the sensor electrode contact point portion 125C in the direction separated from the electrode (GND) 121. The sensor electrode lower end portion 125E is positioned in the upper portion than the electrode (abnormality detection) end portion 123A.

In the case of not performing stirring, the stirring detection sensor electrode 125 and the electrode (GND) 121 are in contact with each other at the sensor electrode contact point portion 125C, and in the case of performing stirring, the stirring detection sensor electrode 125 side is moved, so that the stirring detection sensor electrode 125 and the electrode (GND) 121 are not in contact with each other.

The stirring detection sensor is configured of the stirring detection sensor electrode 125 and the electrode (GND) 121. When the electric signal is conducted between the stirring detection sensor electrode 125 and the electrode (GND) 121, the stirring detection sensor is conducted.

The stirring detection sensor electrode 125 is assembled with a flow detection plate 126 made of an insulation material so as to be sandwiched and fixed between a mounting screw 127 and a mounting nut 128 on the upper side than the sensor electrode lower end portion 125E. The flow detection plate 126 extends downward so as to be immersed into the pigment-based ink 68A, and a flow detection plate lower end portion 126A is positioned in the upper portion than the stirring body 103 so as not to inhibit the stirring operation of the stirrer 101.

The flow detection plate 126 is insulative, and even when the flow detection plate 126 is immersed in the pigment-based ink 68A, the stirring detection sensor is not conducted when the stirring detection sensor electrode 125 and the electrode (GND) 121 are not in contact with each other.

The stirring detection sensor electrode 125 is electrically conducted with the electrode (GND) 121 in the state where the stirrer 101 is stopped, and is connected with the control section 7 by a stirring detection sensor electrode electric wire 125F connected on the outside of the liquid reservation section 111.

In the configuration of this embodiment, when the stirring detection sensor electrode 125 and the electrode (GND) 121 are conducted, the control section 7 judges that the pigment-based ink 68A is not stirred. The sensor electrode contact point portion 125C is arranged in the upper portion than the liquid surface in the ink container in order to judge the electric conduction according to the stirring state.

The connection block 113 is provided with a feeding pipe 801A connected with the path (for ink feeding) 801, a collection pipe 812A connected with the path (for ink collection) 812, a solvent pipe 833A connected with the path (for solvent replenishment) 833, and an exhaust pipe (not illustrated) connected with the path (for exhaust) 814.

These feeding pipe 801A, collection pipe 812A, solvent pipe 833A, and exhaust pipe (not illustrated) are formed of stainless materials of cylindrical shape, and are assembled to the connection block 113 by, for example, press fit.

The feeding pipe 801A is formed with a feeding pipe end portion 801B located in the lower portion than the ink reference liquid surface 131 so as to be immersed in the pigment-based ink 68A, and a feeding tube 801C generated of a fluorine resin is connected on the outside of the liquid reservation section 111.

The collection pipe 812A is connected with a collection tube 812B on the outside of the liquid reservation section 111, and the outflow port to the liquid reservation section 111 is formed with an ink collection returning section 113A to prevent splash when the ink suctioned and collected from the gutter 25 is discharged to the liquid reservation section 111.

The ink collection returning section 113A has an inside diameter larger than the diameter of the flow passage of the collection pipe 812A, and prevents the stirring detection sensor electrode 125 from being dirty and sticky with the ink due to the ink splash. For that, an ink collection returning lower end portion 113B is formed at the position lower than the sensor electrode lower end portion 125E.

In addition, when the ink collection returning lower end portion 113B is immersed in the pigment-based ink 68A stored in the liquid reservation section 111, the gas suctioned together with the ink from the gutter 25 is also discharged from the collection pipe 812A, so that the liquid surface of the pigment-based ink 68A is not stable. For that, the ink collection returning lower end portion 113B is arranged in the upper portion than the electrode (abnormality detection) end portion 123A.

The solvent pipe 833A is connected with a solvent tube 833C on the outside of the liquid reservation section 111. A solvent pipe end portion 833B that is a solvent discharge port for feeding the solvent 69A dissolving the pigment-based ink 68A from the solvent pipe 833A to the liquid reservation section 111 is arranged in the main ink container 31. The solvent pipe end portion 833B is arranged in the upper portion of the sensor electrode tilting portion 125B.

To the main ink container 31, the solvent 69A is replenished from the solvent container 33 regularly (for example, approximately once per 15 minutes) for adjusting the concentration of the pigment-based ink 68A. By taking the configuration according to this embodiment, for the solvent replenishment to the main ink container 31, the solvent 69A is made to flow through the stirring detection sensor electrode 125 to the liquid reservation section 111.

For that, the feeding of the solvent can prevent the contact portion of the sensor electrode contact point portion 125C and the electrode (GND) 121 from being unlikely to be separated in the state where the sensor electrode contact point portion 125C and the electrode (GND) 121 are in contact with each other due to the sticking and drying by the adhesion of the pigment-based ink 68A.

In addition, the pipe end portion of the exhaust pipe (not illustrated) is arranged in the upper portion than the electrode (abnormality detection) end portion 123A so as not to be immersed into the pigment-based ink 68A, and an exhaust tube 814B is connected on the outside of the liquid reservation section 111.

### [the Description of the Stirring Detection Sensor]

Next, the stirring state detection operation at stirring by the stirrer 101 of the main ink container 31 according to this embodiment will be described with reference to FIG. 5. FIG. 5 illustrates the operation state of the stirrer 101 of the main ink container 31 according to this embodiment.

In FIG. 5, the state where the stirrer 101 is operated is illustrated. By the control section 7, the operation of the stirring mechanism is controlled. That is, on the basis of the instruction from the control section 7, the motor 102 is operated to rotate the rotor 104. Then, the stirring body 103 stored in the container bottom surface 111A of the liquid reservation section 111 is also rotated in conjunction with the rotor 104 in the direction illustrated by the arrow of a stirring body rotation direction 132.

Then, inside the liquid reservation section 111, the rotation of the stirring body 103 causes a rotation flow in the entire pigment-based ink 68A, as indicated by the arrow illustrated by an ink rotation flow 133 along the container side surface 111B also for the pigment-based ink 68A. By the ink rotation flow, as illustrated in FIG. 5, in the ink reference liquid surface 131, the liquid surface of the portion of the container side surface 111B becomes high, and is changed into the state like a side wall side liquid surface at stirring 131A, and the liquid surface of the center of the liquid reservation section 111 becomes low, and is changed into the state like a center liquid surface at stirring 131B.

In this way, when the stirrer 101 is operated to stir the pigment-based ink 68A, the rotation flow speed of the pigment-based ink 68A in the portion of the container side surface 111B is increased, and the liquid surface of the pigment-based ink 68A is likely to be high. Even in such a case, the electrode (abnormality detection) 123 is installed near the container side surface 111B so that the pigment-based ink 68A does not overflow from the liquid reservation section 111.

Then, for the stirring detection sensor electrode 125, since the flow detection plate 126 is moved in the direction of the arrow of the ink rotation flow 133, the sensor electrode contact point portion 125C and the electrode (GND) 121 are not electrically conducted, and it can be judged that the pigment-based ink 68A is normally stirred. The ink rotation flow 133 is faster in the vicinity of the container side surface 111B as compared with the container center portion, so that when the stirring detection sensor electrode 125 is installed in the vicinity of the container side surface 111B, the performance easily becomes higher.

By the way, in the inkjet recording device that uses the pigment-based ink, when the pigment-based ink is left without being stirred without executing the printing over a long period, the pigment components contained in the pigment-based ink are precipitated to the bottom portion of the ink container in the ink container, and the stirring body 103 is not normally rotated due to the sticking in the stirring body 103 by the accumulation of the pigment components to the container bottom surface 111A and the failure and the like of the stirrer 101, so that the pigment-based ink cannot be stirred, and a difficulty can be caused in the normal feeding of the pigment-based ink.

It should be noted that even when the control section 7 performs the instruction to operate the stirrer 101, since the stirring body 103 is not normally rotated, the pigment-based ink 68A is not stirred, and the sensor electrode contact point portion 125C and the electrode (GND) 121 remains in the contact state.

In addition, in the conventional inkjet recording device that uses the pigment-based ink, the stirring mechanism is operated only during the ink jetting that is executing the printing. Consequently, when the pigment-based ink is left without operating the inkjet recording device over a long time, the fear that the pigment-based ink can be stuck in the ink path is increased. Therefore, together with the above-described precipitation of the pigment components of the pigment-based ink in the ink container, the pigment-based ink cannot be fed at the restart of the printing, and the printing cannot be performed.

Therefore, to solve such problems, in this embodiment, in the inkjet recording device that uses the pigment-based ink, when the inkjet recording device is rested (the rest mode) and does not execute the printing, the ink circulation in the ink path and the stirring in the ink container are forcibly performed, so that the ink sticking in the ink path and the precipitation of the pigment components in the ink container, which occur when the printing is not performed over a long period are suppressed, and the pigment-based ink is jetted in a short time at the restart of the printing.

Next, its specific configuration will be described, but actually, by executing the program in the control section, the control forcibly performing the ink circulation in the ink path and the stirring in the ink container is performed in the rest mode in which the inkjet recording device is rested, that is, when the printing is not executed.

Hereinbelow, its specific configuration will be described on the basis of the control flow in the control section 7.

### [The Description of the Stirring in the Ink Container and the Ink Circulation in the Ink Path in the Rest Mode]

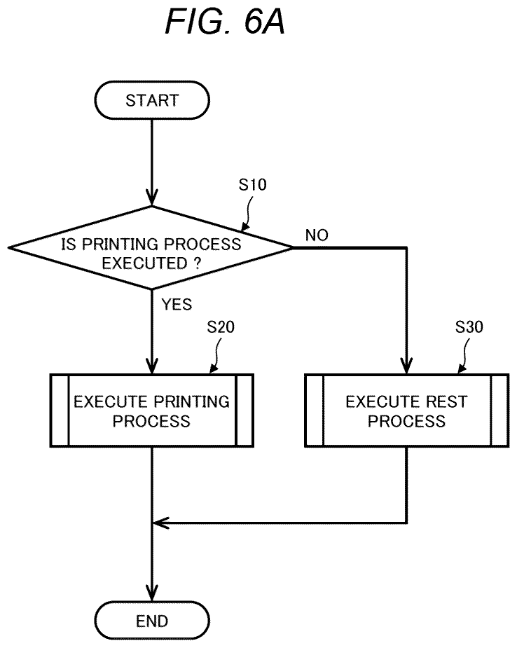

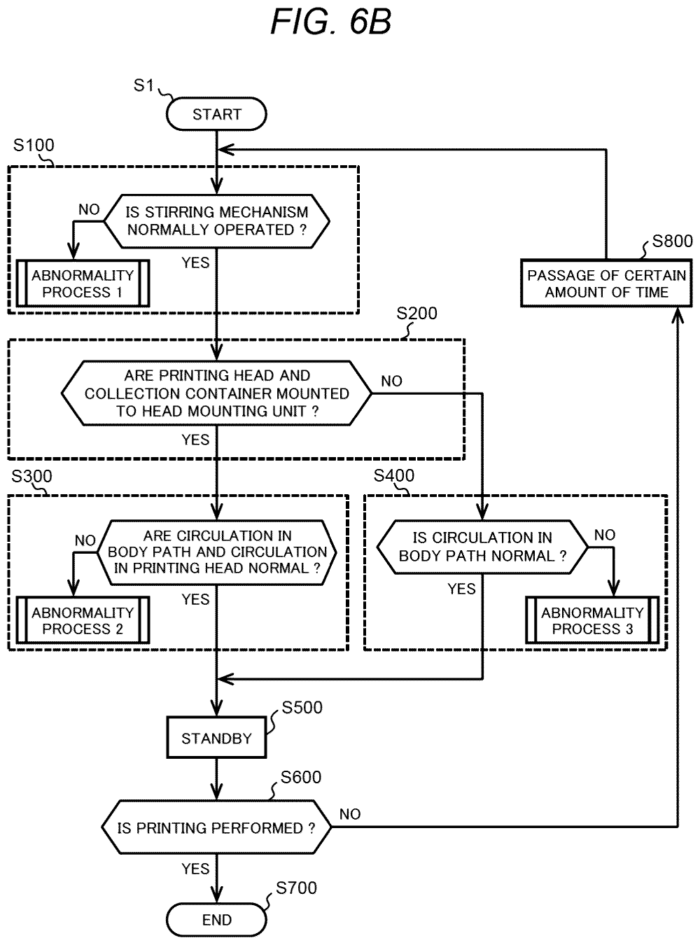

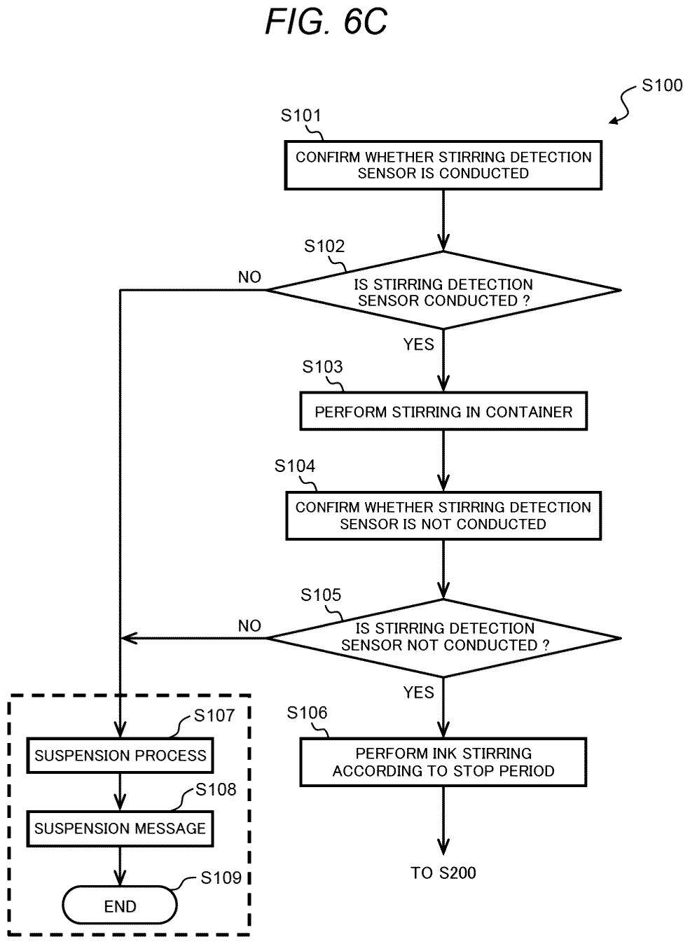

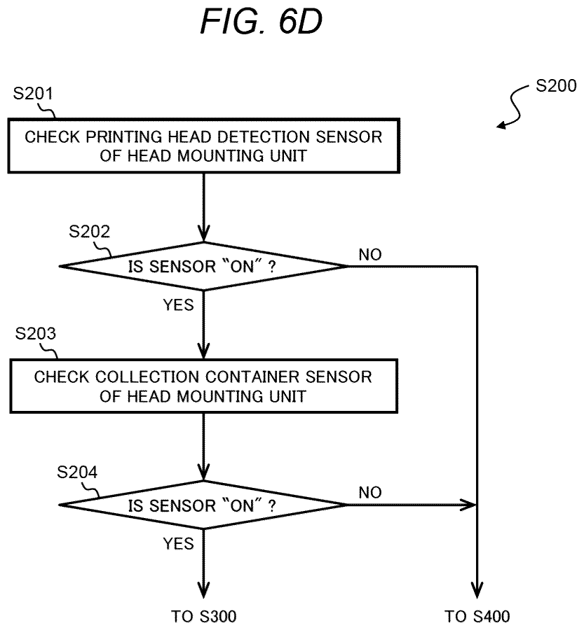

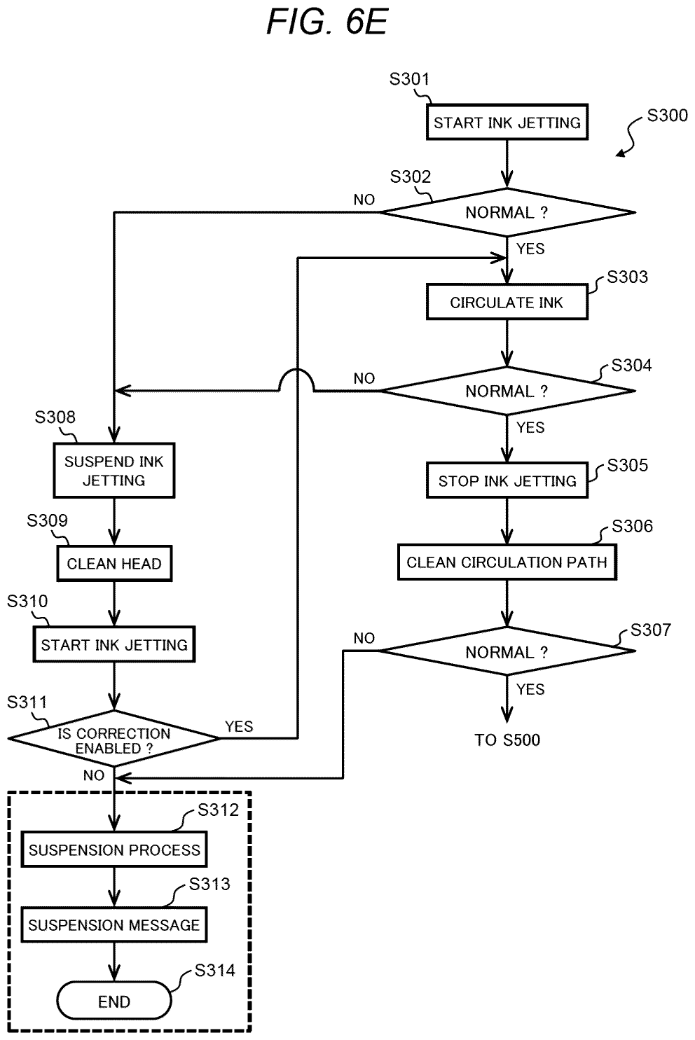

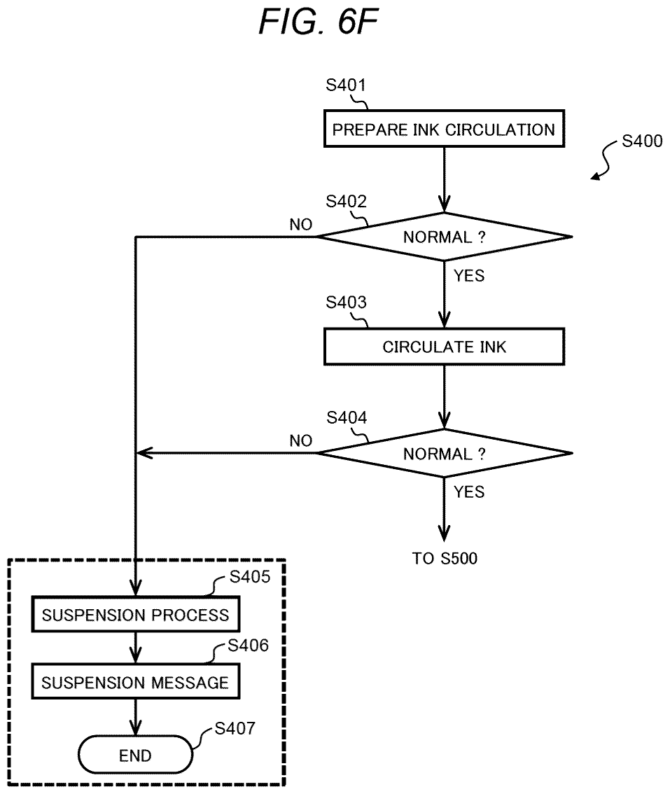

The control flow executing the operations in which when the inkjet recording device 600 is in the state of the rest mode, the pigment-based ink 68A in the ink container 31 is stirred at predetermined time intervals, and in addition, the pigment-based ink 68A is circulated in the ink path will be described with reference to FIGS. 6A to 6F. It should be noted that in this description, also see FIG. 2.

### [The Description of the Entire Control Flow]

First, FIG. 6A illustrates the control flow judging whether or not the inkjet recording device is rested.

### <<Step S10>>

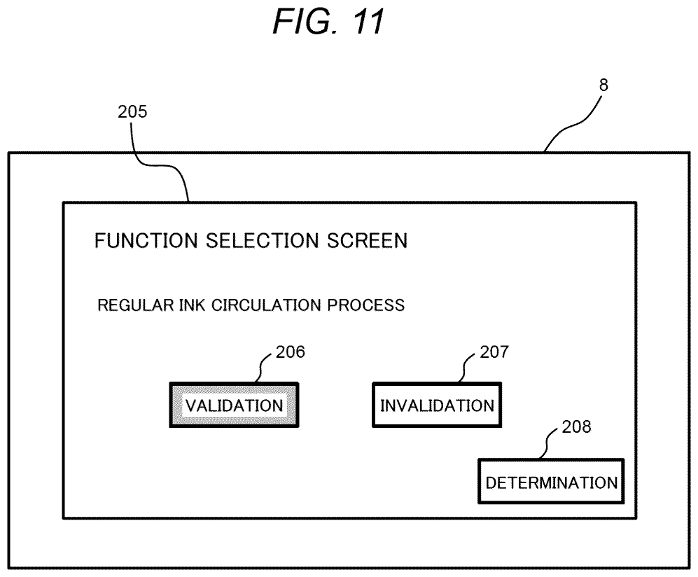

When the power supply of the inkjet recording device is turned on, it is judged in step S10 whether or not the printing process is executed. This judgement can be judged by detecting the printing instruction or the rest instruction inputted by the operator. Alternatively, the passage time from the point in time at the ending of the printing has passed a predetermined time, and it can thus be judged that the inkjet recording device has been changed into the rest state. For example, as illustrated in FIG. 11, under the state of the rest mode, the input button validating or invalidating the process for regularly performing the ink circulation can be selected.

In brief, the judgement whether the printing process is executed or the rest process in which the printing process is stopped is executed is only required to be performed, and various conditions can be used therefor. When in the control step, it is judged that the printing process is executed, the process goes to step S20, and when it is judged that the printing process is not executed, the process goes to step S30. Hereinafter, the “printing mode” and the “rest mode” may be denoted including the claims.

### <<Step S20>>

Since it is judged in step S10 that the printing process is executed, the normal printing process (printing mode) is executed in step S20. Since the printing process is a well-known process and is not the purport of this embodiment, the description thereof is omitted. When the printing process is completed, the process exits to the end, thereby ending the process.

### <<Step S30>>

Since it is judged in step S10 that the printing process is not executed, the rest process (rest mode) is executed in step S30. The rest process has an aim in which when the inkjet recording device is rested and does not execute the printing, the ink circulation in the ink path and the stirring in the ink container are forcibly performed, so that the ink sticking in the ink path and the precipitation of the pigment components in the ink container, which occur when the printing is not performed over a long period are suppressed, and the pigment-based ink is jetted in a short time at the restart of the printing. When the rest process is completed, the process exits to the end, thereby ending the process.

### [The Description of the Entire Control Flow in the Rest Mode]

Next, the specific control flow of the above-described rest process will be described with reference to FIGS. 6B to 6F.

FIG. 6B illustrates the flow of the process in which when the inkjet recording device 600 is in the state of the rest mode, the pigment-based ink 68A in the main ink container 31 is stirred and the pigment-based ink 68A is circulated in the ink path.

### <<Step S1>>

First, in step S1, when the inkjet recording device 600 is in the rest state over a predetermined time, the ink circulation process is started. When the ink circulation process is started, the process goes to step S100.

### <<Step S100>>

In step S100, the control section 7 executes the operation of the stirring mechanism mounted to the lower portion of the main ink container 31 to prevent the pigment components of the pigment-based ink from being precipitated. Then, when the stirring mechanism is normally operated, the process goes to step S200, and when the stirring mechanism is not normally performed, an abnormality process 1 is executed. The abnormality process 1 will be described later.

It should be noted that the stirring operation in step S100 may be stopped after the stirring is performed only for a predetermined time, so that the routine goes to step S200, or may go to step S200 while continuing the stirring operation. Hereinafter, after the stirring operation is performed, the process goes to step S200.

### <<Step S200>>

In step S200, the confirmation whether or not the printing head 2 and the collection container 4 are mounted to the head mounting unit 3 is executed. When it can be confirmed that the printing head 2 and the collection container 4 are mounted to the head mounting unit 3, the process goes to step S300, and when the printing head 2 and the collection container 4 are not mounted, the process goes to step S400. It should be noted that when the printing head 2 and the collection container 4 are not mounted, the state where the printing head 2 is fixed to the printing head fixing fixture 13 illustrated in FIG. 1 is assumed.

### <<Step S300>>

In step S300, the operations of the ink circulation in the ink path of the body 1 and the ink circulation in the printing head 2 are executed to judge the presence or absence of an abnormality therein. The ink circulation in the printing head 2 is executed since the printing head 2 is mounted to the head mounting unit 3 and the ink is not scattered to the outside. When the ink circulations of both are normally operated, the process goes to step S500, and the ink circulations of both are not normally operated, an abnormality process 2 is executed. The abnormality process 2 will be described later.

### <<Step S400>>

In step S400, the operation of the ink circulation in the ink path of the body 1 is executed to judge the presence or absence of an abnormality therein. Here, the state where the printing head 2 is fixed to the printing head fixing fixture 13 is assumed. Thus, since there is possibility that the ink is scattered to the outside, the operation of the ink circulation in the printing head 2 is not executed. When the ink circulation is normally operated, the process goes to step S500, and when the ink circulation is not normally operated, an abnormality process 3 is executed.

### <<Step S500>>

In step S500, the operation of the ink circulation in step S300 or step S400 is executed over a predetermined time, and thereafter, the operations of the stirring of the ink and the circulation of the ink are stopped to be in the standby state. It should be noted that when the stirring operation of the ink in step S100 is continued, the inkjet recording device is controlled according to the operation of step S300 or step S400. In this way, by stopping the operations of the stirring of the ink and the circulation of the ink, excessive power consumption is avoided. In this state, the process goes to step S600.

### <<Step S600>

In step S600, it is judged whether or not the printing is restarted by the operator. When the operator inputs the instruction to perform the printing, the routine goes to step S700, and when the operator does not input the instruction to perform the printing, the process goes to step S800.

### <<Step S700>>

In step S700, since the instruction to perform the printing is inputted, the rest process is ended, and the process of the flow illustrated in steps S10 and S20 of FIG. 6A is executed.

### <<Step S800>>

In step S800, since the instruction to perform the printing is not inputted, it is detected that a predetermined (here, a certain amount of) time has passed. When the predetermined time has passed, the process returns to step S100 again to repeat the operation of the above-described respective control steps. It should be noted that the predetermined time is measured by the timer incorporated in the MPU 301 of the control section 7 by using a time to start step S1 as a starting point. Thereafter, the above-described respective control steps are executed each time the predetermined time passes.

Next, the detailed control flows of steps S100, S200, S300, and S400 will be additionally described.

### [The Description of the Detailed Control Flow of Step S100]

FIG. 6C illustrates the control flow of the stirring mechanism operation of step S100.

### <<Step S101>>

In step S101, in order to confirm whether the stirring detection sensor electrode 125 and the electrode (GND) 121 are conducted in the state where the stirrer 101 is not operated, the sensor signal is detected to go to step S102.

### <<Step S102>>

In step S102, it is judged whether the stirring detection sensor configured of the stirring detection sensor electrode 125 and the electrode (GND) 121 is electrically conducted. When it is judged that the stirring detection sensor is conducted, “Yes” (normal) is judged to go to step S103. On the other hand, when the stirring detection sensor electrode 125 is not conducted, “No” (abnormal) is judged to go to step S107.

### <<Step S103>>

In step S103, the stirring operation of the pigment-based ink 68A in the main ink container 31 and the auxiliary ink container 32 by the stirrer 101 is started. When the stirring operation of the pigment-based ink 68A is started, the process goes to step S104.

### <<Step S104>>

In step S104, to confirm whether the pigment-based ink 68A in the main in container 31 and the auxiliary ink container 32 is normally stirred and the stirring detection sensor electrode 125 and the electrode (GND) 121 are in the non-conductive state, the sensor signal is detected to go to step S105.

### <<Step S105>>

In step S105, it is judged whether the stirring detection sensor is not conducted. When the stirring detection sensor is not conducted, “Yes” (normal) is judged to go to step S106. On the other hand, when the stirring detection sensor is conducted, “No” (abnormal) is judged to go to step S107.

### <<Step S106>>

In step S106, the stirring operation of the pigment-based ink 68A by the stirrer 101 is performed according to the period in which the inkjet recording device 600 is rested. Here, as the stopping period of the inkjet recording device 600 is longer, the stirring operation of the pigment-based ink 68A is required to be performed more, so that the stirring is set according to the rest period. The stirring time can be previously calculated by an experiment and the like, and be stored in a table for use. Then, after the stirring of the pigment-based ink 68A is performed, the process goes to step S200.

### <<Step S107>> to <<Step S109>>

Steps S107 to S109 correspond to the abnormality process 1, and in step S107, the rest mode suspension process is performed, the suspension message is displayed on the operation display section 8 in step S108, and the operation of the inkjet recording device 600 is ended in the state where the suspension message is displayed on the operation display section 8 in step S109.

### [The Description of the Detailed Control Flow of Step S200]

FIG. 6D illustrates the control flow of the head mounting sensor of step S200.

### <<Step S201>>

First, in step S201, it is confirmed whether the magnetic sensor B 84 of the head mounting unit 3 is in the “ON” state (the magnet B 86 assembled to a lid member 83 is detected), and it is confirmed whether the magnetic sensor C 28 of the printing head 2 is in the “ON” state (the magnet C 87 assembled to a cleaning block 81 is detected). Thereafter, the process goes to step S202.

### <<Step S202>>

In step S202, from the result of the confirmation of step S201, when the magnetic sensor B 84 is in the “ON” state and the magnetic sensor C 28 is in the “ON” state, “YES” (the printing head 2 is mounted to the head mounting unit 3) is judged to go to step S203.

When from the confirmation result of step S201, either the magnetic sensor B 84 or the magnetic sensor C 28 is in the “OFF” state, “NO” (the printing head 2 is not mounted to the head mounting unit 3) is judged to go to step S400.

### <<Step S203>>

In step S203, it is confirmed whether the magnetic sensor A 76 of the head mounting unit 3 is in the “ON” state (the magnet A 75 of the collection container 4 is detected). Thereafter, the process goes to step S204.

### <<Step S204>>

In step S204, when from the confirmation result of step S203, the magnetic sensor A 76 is in the “ON” state, “YES” (the collection container 4 is mounted to the head mounting unit 3) is judged to go to step S300.

On the other hand, when from the confirmation result of step S203, the magnetic sensor A 76 is in the “OFF” state, “NO” (the collection container 4 is not mounted to the head mounting unit 3, or the liquid (not illustrated) is accumulated in the collection container 4 and the float 74 is in the float state) is judged to go to step S400.

### [The Description of the Detailed Control Flow of Step S300]

FIG. 6E illustrates the control flow of the ink path circulation and the ink circulation in the printing head 2 of step S300. The state at this time is the state where the printing head 2 is set to the head mounting unit 3.

### <<Step S301>>

In step S301, the pigment-based ink 68A in the main ink container 31 and the auxiliary ink container 32 is made into the state where the pigment-based ink 68A is sufficiently stirred, and by the control of the printing control means, the jetting of the ink particle 68B made to be particulate from the nozzle 21 is started.

### <<Step S302>>

In step S302, it is judged whether the ink jetting in the printing head 2 is normal. When the ink jetting is normal, “Yes” is judged to go to step S303. When there is an abnormality in the ink jetting, “No” is judged to go to step S308.

### <<Step S303>>

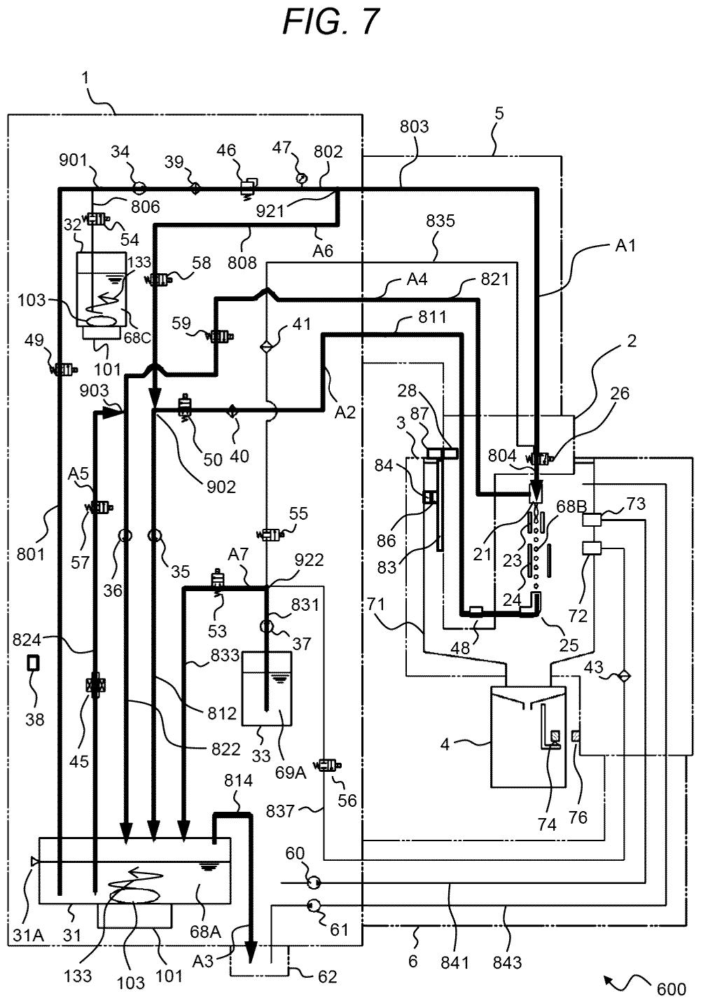

In step S303, in the state where the printing head 2 is set to the head mounting unit 3, the ink circulation process in the ink path of the body 1 and the ink circulation process in the printing head 2 are executed, and their operations will be described with reference to FIG. 7. It should be noted that the ink path in which the ink is circulated illustrated in FIG. 7 is “a first ink circulation path” referred in the claims.

In FIG. 7, the inkjet recording device 600 according to this embodiment is in the state where the printing head 2 is set to the head mounting unit 3, and the flows of the liquid (ink) and the air when the ink circulation in the ink path of the body 1 and the ink circulation in the printing head 2 are indicated by thick lines (A1 to A7).

In the ink feeding paths (the paths 801 to 804), the solenoid valve (for feeding) 49 is energized to open the flow passage, and the switching valve 26 is energized to connect the ink feeding path with the nozzle 21, and the pump (for feeding) 34 is operated, so that as indicated by the thick line of the arrow A1, the pigment-based ink 68A accommodated in the ink container 31 of the body 1 is fed to the nozzle 21 of the printing head 2 to be discharged as the ink particle 68B from the nozzle 21. The ink particle 68B is brought into the state where the voltage is applied to the charging electrode 23, and its charging amount is confirmed by the charging sensor 48.

In the ink collection paths 811 and 812, the solenoid valve (for collection) 50 is energized to open the flow passage, and the pump (for collection) 35 is operated, so that as indicated by the thick line of the arrow A2, the ink particle 68B and the air around the printing head 2 are suctioned from the gutter 25, and are suctioned and pumped to the ink container 31 of the body 1.

In the ink collection paths 811 and 812, since the pigment-based ink 68A and the air flow in the gas-liquid mixing state, the solvent components of the pigment-based ink 68A are dissolved into the air, and the air becomes a solvent gas, and is made to flow into the ink container 31. The ink flowing into the ink container 31 is accommodated into the bottom portion, and the air that becomes the solvent gas is discharged to the outside of the body 1 as the solvent gas, as indicated by the thick line of the arrow A3.

In the inkjet recording device 600, since in this way, the solvent components in the pigment-based ink 68A are discharged as the solvent gas to the outside of the device, when the operation time becomes longer, the rate of the solvent components in the pigment-based ink 68A becomes small, and the concentration of the pigment-based ink 68A is brought into the high state. In addition, on the contrary, when the operation time is short, the concentration of the ink is brought into the low state by the solvent 69A which flows into the ink container 31 by the nozzle cleaning process and the like.

Thus, in the paths (for viscosity measurement) 824 and 822, the solenoid valve (for viscosity measurement) 57 is energized to open the flow passage, and the pump (for circulation) 36 is operated, so that as indicated by the thick line of the arrow A5, the pigment-based ink 68A in the ink container 31 is sent to the viscosity measurement device 45, and the viscosity (converted into concentration) of the pigment-based ink 68A is regularly measured.

The detection value of the measured viscosity is inputted to the control section 7. As a result, when the concentration of the pigment-based ink 68A is low, the control section 7 performs the control so as to replenish the pigment-based ink 68C in the auxiliary ink container 32 to the ink container 31, and when the concentration of the pigment-based ink 68A is high, as indicated by the thick line of the arrow A7, the control section 7 performs the control so as to replenish the solvent 69A in the solvent container 33 to the ink container 31. In this way, in the inkjet recording device 600, the viscosity of the pigment-based ink 68A is controlled so as to be within the managing value range.

In addition, in the ink circulation paths 821 and 822, as indicated by the thick line of the arrow A1, in the state where the pigment-based ink 68A is fed from the ink container 31 to the nozzle 21, the solenoid valve (for circulation) 59 is energized to open the flow passage, and the pump (for circulation) 36 is operated, so that at least part of the pigment-based ink 68A fed to the nozzle 21 is suctioned to the pump (for circulation) 36, and the pigment-based ink 68A is circulated so as to return to the ink container 31 by the flow indicated by the thick line of the arrow A3.

In addition, before the switching valve 26 is energized, the solenoid valve (for body circulation) 58 is energized to open the flow passage, and the pump (for circulation) 36 is operated, so that as indicated by the thick line of the arrow A6, the path (for body circulation) 808 can also circulate the pigment-based ink 68A.

The pigment-based ink 68A in the ink container 31 and the pigment-based ink 68C in the auxiliary ink container 32 are stirred by the stirrer 101 and the stirring body 103.

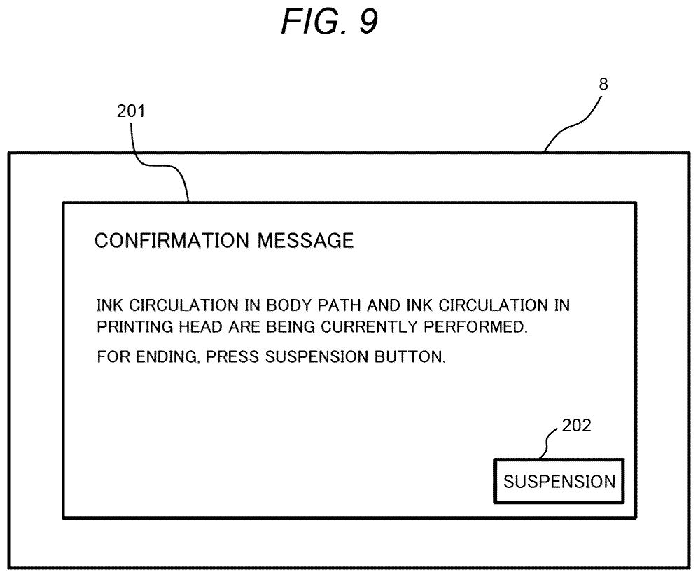

When the ink circulation is being executed, the screen like FIG. 9 is displayed. It should be noted that the screen of FIG. 9 is displayed on the touch panel type operation display section 8.

That is, in order that the user can confirm that the ink circulation is being performed in the ink path of the body 1 and the ink circulation is performed in the printing head 2, a confirmation message 201 like “Ink circulation in body path and ink circulation in printing head are being currently performed. For ending, press the suspension button.” is displayed on the touch panel type operation display section 8. In addition, in order that the user can suspend the ink circulation, a suspension button 202 is displayed on the touch panel type display section 8.

Returning to FIG. 6E, the next control step will be described.

### <<Step S304>>

In step S304, it is judged whether the ink circulation in the ink path of the body 1 is normal. In this judgement, the detection signal of the charging sensor 48 and the detection signal of the pressure sensor 47 are used. When the ink circulation is normal, “Yes” is judged to go to step S305. On the other hand, when there is an abnormality in the ink circulation, “No” is judged to go to step S308.

### <<Step S305>>

In step S305, since it is judged that the ink circulation is normal, the ink jetting in the printing head 2 is stopped to go to step S306.

### <<Step S306>>

In step S306, to confirm whether the cleaning process in the ink circulation path is normal, various sensor signals are detected to go to step S307.

### <<Step S307>>

In step S307, it is judged whether the cleaning process in the ink circulation path is normal. In this judgement, the detection signal of the pressure sensor 47 is used. When the cleaning process in the ink circulation path is normal, “Yes” is judged to go to step S500. When there is an abnormality in the cleaning process in the ink circulation path, “No” is judged and process goes to step S312.

### <<Step S308>>

When an abnormality is detected in the ink circulation in step S302 or step S304, the ink jetting is suspended in this step, and process goes to step S309.

### <<Step S309>>

In step S309, the head cleaning process is executed, and process goes to step S310.

### <<Step S310>>

In step S310, after the head cleaning of step S309, the ink jetting is executed again, and after it is confirmed whether the abnormality in the ink jetting has been corrected, the process goes to step S311.

### <<Step S311>>

In step S311, it is judged whether the abnormality in the ink jetting has been corrected. In this judgement, the detection signal of the charging sensor 48 is used. When the abnormality in the ink jetting has been corrected, “Yes” is judged, and process goes to step S303, and the ink circulation in the ink path of the body 1 and the ink circulation in the printing head 2 are performed again. On the other hand, when the abnormality in the ink jetting has not been corrected, “No” is judged, and process goes to step S312.

### <<Step S312>> to <<Step S314>>

Steps S312 to S314 correspond to the abnormality process 2, and in step S312, the rest mode suspension process is performed, the suspension message is displayed on the operation display section 8 in step S313, and the operation of the inkjet recording device 600 is ended in step S314 in the state where the suspension message is displayed on the operation display section 8.

[The description of the detailed control flow of step S400] FIG. 6F illustrates the control flow of the ink circulation in the ink path of step S400. The state at this time is the state where the printing head 2 is fixed to the printing head fixing fixture 13.

### <<Step S401>>

First, in step S401, it is confirmed whether the ink circulation in the ink path of the body 1 can be normally executed, and thereafter, the process goes to step S402.

### <<Step S402>>

In step S402, it is judged whether the ink circulation in the ink path of the body 1 can be normally executed. In this judgement, the detection signal of the pressure sensor 47 is used. When the ink circulation in the ink path of the body 1 can be normally executed, “Yes” is judged, and process goes to step S403. On the other hand, when the ink circulation in the ink path of the body 1 cannot be normally executed, “No” is judged, and process goes to step S405.

### <<Step S403>>

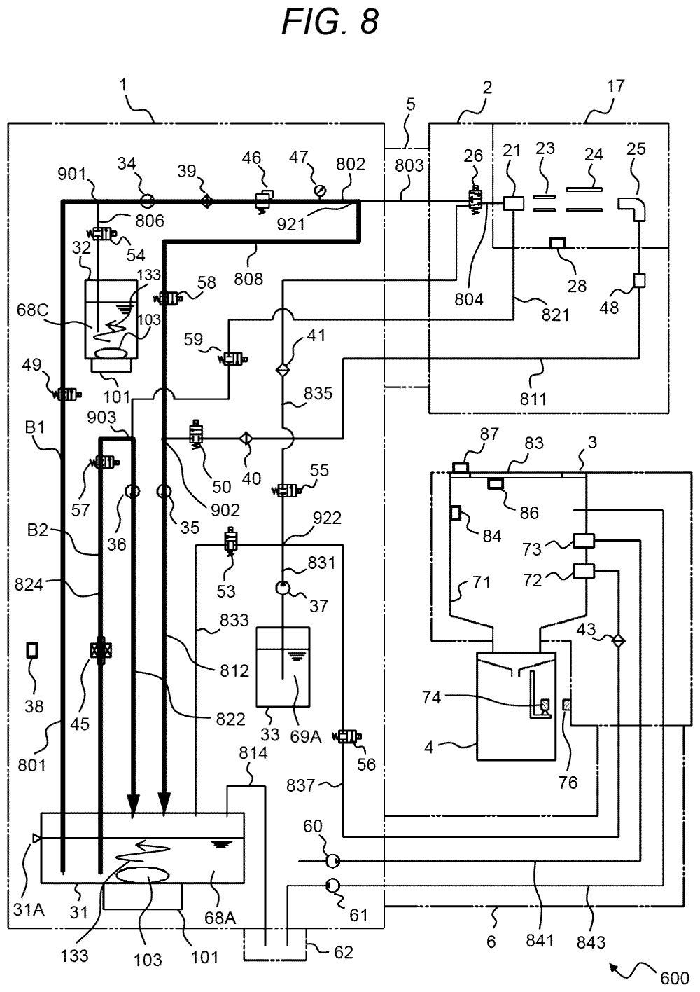

In step S403, in the state where the printing head 2 is not set to the head mounting unit 3, the ink circulation process in the ink path of the body 1 is executed, and its operation will be described with reference to FIG. 8. It should be noted that the ink path in which the ink is circulated illustrated in FIG. 8 is “a second ink circulation path” referred in the claims.

In FIG. 8, the inkjet recording device 600 according to this embodiment is in the state where the printing head 2 is not set to the head mounting unit 3, and the flows of the liquid (ink) and the air when the ink circulation in the body 1 is performed are indicated by the thick lines (B1 and B2).

In the body 1, the solenoid valve (for feeding) 49 and the solenoid valve (for body circulation) 58 are energized to open the flow passage, and the pump (for feeding) 34 and the pump (for collection) 35 are operated, so that as indicated by the thick line of the arrow B1, the pigment-based ink 68A accommodated in the ink container 31 of the body 1 is circulated in such a manner that the pigment-based ink 68A passes through the solenoid valve (for feeding) 49, the pump (for feeding) 39, the filter (for feeding) 39, the pressure regulation valve 46, the pressure sensor 47, the solenoid valve (for body circulation) 58, and the pump (for collection) 35 to return to the ink container 31.

In addition, in the body 1, the solenoid valve (for viscosity measurement) 57 is energized to open the flow passage, and the pump (for circulation) 36 is operated, so that as indicated by the thick line of the arrow B2, the pigment-based ink 68A accommodated in the ink container 31 of the body 1 is circulated in such a manner that the pigment-based ink 68A passes through the viscosity measurement device 45, the solenoid valve (for viscosity measurement) 57, and the pump (for circulation) 36 to return to the ink container 31.

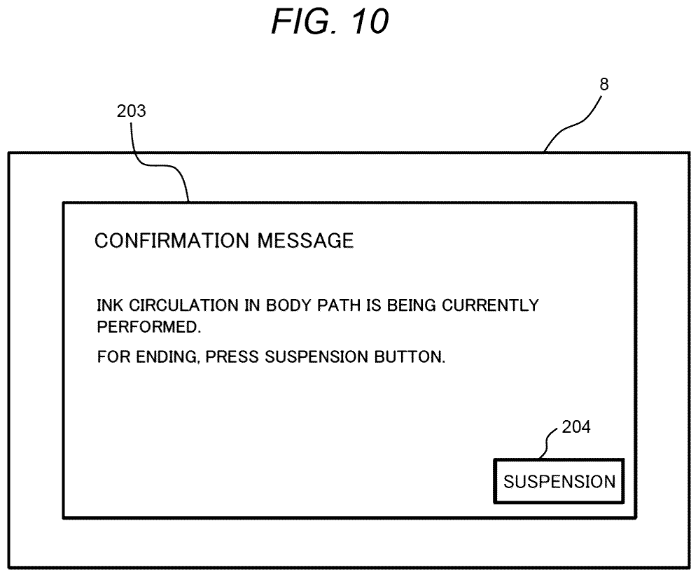

In addition, when at the timing of the ink circulation in the body 1, the viscosity measurement device 45 is used to measure the viscosity of the pigment-based ink 68A, the state of the pigment-based ink 68A is easily grasped when the inkjet recording device is used next. When the ink circulation is being executed, the screen like FIG. 10 is displayed. It should be noted that the screen of FIG. 10 is displayed on the touch panel type operation display section 8.

That is, in order that the user can confirm that the ink circulation is being performed in the path of the body 1, a confirmation message 203 like “Ink circulation in body path is being currently performed. For ending, press the suspension button.” is displayed on the touch panel type operation display section 8. In addition, in order that the user can suspend the ink circulation, a suspension button 204 is displayed on the touch panel type display section 8. Returning to FIG. 6F, the next control step will be described.

### <<Step S404>>

In step S404, it is judged whether the ink circulation is normal. In this judgement, the detection signal of the pressure sensor 47 is used. When the ink circulation is normal, “Yes” is judged to go to step S500. On the other hand, when there is an abnormality in the ink circulation, “No” is judged, and the process goes to step S405.

### <<Step S405>> to <<Step S407>>

Steps S405 to S407 correspond to the abnormality process 3, and in step S405, the rest mode suspension process is performed, the suspension message is displayed on the operation display section 8 in step S406, and the operation of the inkjet recording device 600 is ended in step S407 in the state where the suspension message is displayed on the operation display section 8.

It should be noted that when the inkjet recording device 600 selects that the regular ink circulation process is performed during the rest mode, the screen like FIG. 11 is displayed. It should be noted that the screen of FIG. 11 is displayed on the touch panel type operation display section 8.

Then, the inkjet recording device 600 can be set so as to execute the regular ink circulation in the rest state by selecting a validation button 206 displayed on a function selection screen 205 and then by pressing a determination button 208.

On the other hand, the inkjet recording device 600 can be set so as not to execute the regular ink circulation by selecting an invalidation button 207 displayed on the function selection screen 205 and then by pressing the determination button 208.

In this embodiment, as the initial setting, the execution of the regular ink circulation process is valid during the rest, and the ink sticking in the ink path can be prevented without operating the function selection screen 205 again.

As described above, according to the present invention, an inkjet recording device is provided with a printing head having a nozzle making a pigment-based ink to be fed into an ink particle to discharge the ink particle, a charging electrode charging the ink particle discharged from the nozzle, a deflection electrode deflecting the ink particle charged by the charging electrode, and a gutter collecting the unused ink not used for printing, an ink container reserving the pigment-based ink and provided with a stirring mechanism stirring the reserved pigment-based ink, a first ink circulation path feeding the pigment-based ink in the ink container to the printing head and collecting the pigment-based ink into the ink container, a second ink circulation path not feeding the pigment-based ink in the ink container to the printing head and collecting the pigment-based ink into the ink container, and a control section controlling the operations of the printing head and the stirring mechanism. The control section executes a printing mode performing a printing operation and a rest mode not performing the printing operation. In the rest mode, the control section forcibly performs the stirring in the ink container and the circulation of the ink in the first ink circulation path including the printing head or the circulation of the ink in the second ink circulation path not including the printing head.

With this, in the inkjet recording device that uses the pigment-based ink, when the printing is not performed, the stirring in the ink container and the ink circulation in the ink circulation path are forcibly performed, so that the ink sticking in the ink circulation path and the precipitation of the pigment components in the ink container, which occur when the printing is not performed over a long period can be suppressed, and the pigment-based ink can be jetted in a short time at the restart of the printing.

In addition, the ideas of step S200, step S300, and step S400 of FIG. 6B described above are applicable also to the typical inkjet recording device not provided with the pigment-based ink and the stirring mechanism therefor (it should be noted that step S100 is not executed). The constitution of this case is as follows.

An inkjet recording device includes: a printing head having a nozzle making an ink to be fed into an ink particle to discharge the ink particle, a charging electrode charging the ink particle discharged from the nozzle, a deflection electrode deflecting the ink particle charged by the charging electrode, and a gutter collecting the unused ink not used for printing; a head mounting unit accommodating the printing head and collecting the ink particle discharged from the printing head; an ink container reserving the ink; a first ink circulation path including the printing head, feeding the ink in the ink container to the printing head, and collecting the ink into the ink container while circulating the ink; a second ink circulation path not including the printing head, not feeding the ink in the ink container to the printing head, and collecting the ink into the ink container while circulating the ink; and a control section controlling the operation of the printing head and the circulation of the ink. The control section executes a printing mode performing a printing operation and a rest mode not performing the printing operation, and in the rest mode, the control section performs the circulation of the ink in the first ink circulation path including the printing head or the circulation of the ink in the second ink circulation path not including the printing head.

It should be noted that the present invention is not limited to the embodiments described above, and includes various modification. The embodiments described above have been described in detail to simply describe the present invention, and are not necessarily required to include all the described configurations. In addition, part of the configuration of one embodiment can be replaced with the configurations of other embodiments, and in addition, the configuration of the one embodiment can also be added with the configurations of other embodiments. In addition, part of the configuration of each of the embodiments can be subjected to addition, deletion, and replacement with respect to other configurations.

### REFERENCE SIGNS LIST

1: body, 2: printing head, 3: head mounting unit, 4: collection container, 5: cable (for printing head), 6: cable (for head mounting unit), 7: control section, 8: operation display section, 11: belt conveyor, 12A: printing target, 12B: printing target, 13: printing head fixing fixture, 16: head base, 17: protective cover, 18: start button, 19: stop button, 20: display section, 21: nozzle, 23: charging electrode, 24: deflection electrode, 24A: plus electrode, 24B: ground electrode, 25: gutter, 26: switching valve, 28: magnetic sensor C, 31: ink container, 31A: liquid surface level sensor, 32: auxiliary ink container, 33: solvent container, 34: pump (for feeding), 35: pump (for collection), 36: pump (for circulation), 37: pump (for solvent), 39: filter (for feeding), 40: filter (for collection), 41: filter (for nozzle cleaning), 43: filter (for head cleaning), 45: viscosity measurement device, 46: pressure regulation valve, 47: pressure sensor, 48: charging sensor, 49: solenoid valve (for feeding), 50: solenoid valve (for collection), 53: solenoid valve (for solvent replenishment), 54: solenoid valve (for ink replenishment), 55: solenoid valve (for nozzle cleaning), 56: solenoid valve (for head cleaning), 57: solenoid valve (for viscosity measurement), 58: solenoid valve (for body circulation), 59: solenoid valve (for circulation), 60: pump (for drying), 61: pump (for suctioning), 62: exhaust duct connection section, 68A: pigment-based ink, 68B: ink particle, 68B1: ink particle, 68B2: charging charge, 68C: pigment-based ink, 69A: solvent, 71: cleaning tank, 72: cleaning nozzle, 73: air feeding nozzle, 74: float, 76: magnetic sensor A, 81A: head mounting section, 83: lid member, 84: magnetic sensor B, 86: magnet B, 87: magnet C, 91: fixing section, 92: fixing jig (for conveyor), 93: fitting section, 101: stirrer, 102: motor, 103: stirring body, 104: rotor, 111: liquid reservation section, 111A: liquid reservation section bottom portion, 111B: liquid reservation section side surface, 111C: liquid reservation section connection section, 112: seal member, 113: connection block, 113A: ink collection returning section, 113B: ink collection returning lower end portion, 114: fixing lid, 121: electrode (GND), 121A: electrode (GND) end portion, 121B: electrode (GND) electric wire, 122: electrode (reference), 122A: electrode (reference) end portion, 122B: electrode (reference) electric wire, 123: electrode (abnormality detection), 123A: electrode (abnormality detection) end portion, 123B: electrode (abnormality detection) electric wire, 125: stirring detection sensor electrode, 125A: stirring detection sensor electrode flat portion, 125B: stirring detection sensor electrode tilting portion, 125C: stirring detection sensor electrode contact point portion, 125D: stirring detection sensor electrode tilting portion, 125E: stirring detection sensor electrode lower end portion, 125F: stirring detection sensor electrode electric wire, 126: flow detection plate, 126A: flow detection plate lower end portion, 127: mounting screw, 128: mounting nut, 131: ink reference liquid surface, 131A: side wall side liquid surface at stirring, 131B: center liquid surface at stirring, 132: stirring body rotation direction, 133: ink rotation flow, 201: confirmation message during ink circulation in body path and ink circulation in printing head, 202: suspension button of ink circulation in body path and ink circulation in printing head, 203: confirmation message during ink circulation in body path, 204: suspension button of ink circulation in body path, 205: function selection screen, 206: validation button, 207: invalidation button, 208: determination button, 301: MPU, 302: bus line, 306: ROM, 307: RAM, 311: viscosity measurement circuit, 312: pressure detection circuit, 313: liquid surface detection circuit, 314: pump control circuit, 315: solenoid valve driving circuit, 321: air pump control circuit, 322: collection container sensor detection circuit, 323: printing head detection circuit, 324: head mounting unit detection circuit, 325: stirring detection circuit, 326: stirring mechanism control circuit, 331: excitation voltage generation circuit, 332: deflection voltage generation circuit, 341: phase searching charging signal generation circuit, 342: printing charging signal generation circuit, 343: D/A converter, 344: amplification circuit, 351: phase judgement circuit, 352: A/D converter, 353: amplification circuit, 600: inkjet recording device, 801-804: path (for feeding), 801A: feeding pipe, 801B: feeding pipe end portion, 801C: feeding tube, 806: path (for replenishment), 808: path (for body circulation), 811, 812: path (for collection), 812A: collection pipe, 812B: collection tube, 814: path (for exhaust), 821, 822: path (for head circulation), 824: path (for viscosity measurement), 831: path (for solvent feeding), 833: path (for solvent replenishment), 833A: solvent pipe, 833B: solvent pipe end portion, 833C: solvent tube, 835: path (for nozzle cleaning), 837: path (for head cleaning), 841: path (for air feeding), 843: path (for air suctioning), 901-903: joining path, 921, 922: branching path.

1. An inkjet recording device comprising:
a printing head having a nozzle making an ink to be fed into an ink particle to discharge the ink particle, a charging electrode charging the ink particle discharged from the nozzle, a deflection electrode deflecting the ink particle charged by the charging electrode, and a gutter collecting the unused ink not used for printing;
a head mounting unit accommodating the printing head and collecting the ink particle discharged from the printing head;
an ink container reserving the ink;
a first ink circulation path including the printing head, feeding the ink in the ink container to the printing head, and collecting the ink into the ink container while circulating the ink;
a second ink circulation path not including the printing head, not feeding the ink in the ink container to the printing head, and collecting the ink into the ink container while circulating the ink; and
a control section controlling the operation of the printing head and the circulation of the ink,
wherein the control section executes a printing mode performing a printing operation and a rest mode not performing the printing operation, and
wherein in the rest mode, the control section performs the circulation of the ink in the first ink circulation path including the printing head or the circulation of the ink in the second ink circulation path not including the printing head.

2. The inkjet recording device according to claim 1,
wherein in the rest mode, the control section forcibly performs the circulation of the ink in the first ink circulation path including the printing head when the printing head is accommodated in the head mounting unit.

3. The inkjet recording device according to claim 1,
wherein in the rest mode, the control section forcibly performs the circulation of the ink in the second ink circulation path not including the printing head when the printing head is not accommodated in the head mounting unit.

4. The inkjet recording device according to claim 1,
wherein in the rest mode, the control section executes the circulation of the ink in the first ink circulation path including the printing head or the circulation of the ink in the second ink circulation path not including the printing head each time a first predetermined time passes.

5. An inkjet recording device comprising:
a printing head having a nozzle making a pigment-based ink to be fed into an ink particle to discharge the ink particle, a charging electrode charging the ink particle discharged from the nozzle, a deflection electrode deflecting the ink particle charged by the charging electrode, and a gutter collecting the unused ink not used for printing;
a head mounting unit accommodating the printing head and collecting the ink particle discharged from the printing head;
an ink container reserving the pigment-based ink and provided with a stirring mechanism stirring the pigment-based ink;
a first ink circulation path including the printing head, feeding the pigment-based ink in the ink container to the printing head, and collecting the pigment-based ink into the ink container while circulating the pigment-based ink;
a second ink circulation path not including the printing head, not feeding the pigment-based ink in the ink container to the printing head, and collecting the pigment-based ink into the ink container while circulating the pigment-based ink; and
a control section controlling the operations of the printing head and the stirring mechanism,
wherein the control section executes a printing mode performing a printing operation and a rest mode not performing the printing operation, and
wherein in the rest mode, the control section performs the stirring of the pigment-based ink in the ink container and the circulation of the ink in the first ink circulation path including the printing head or the circulation of the ink in the second ink circulation path not including the printing head.

6. The inkjet recording device according to claim 5,
wherein in the rest mode, the control section forcibly performs the stirring in the ink container and the circulation of the ink in the first ink circulation path including the printing head when the printing head is accommodated in the head mounting unit.

7. The inkjet recording device according to claim 5,
wherein in the rest mode, the control section forcibly performs the stirring in the ink container and the circulation of the ink in the second ink circulation path not including the printing head when the printing head is not accommodated in the head mounting unit.

8. The inkjet recording device according to claim 5,
wherein in the rest mode, the control section stops the stirring of the pigment-based ink in the ink container when a second predetermined time passes, and thereafter, executes the circulation of the ink in the first ink circulation path including the printing head or the circulation of the ink in the second ink circulation path not including the printing head.

9. The inkjet recording device according to claim 5,
wherein in the rest mode, the control section executes the circulation of the ink in the first ink circulation path including the printing head or the circulation of the ink in the second ink circulation path not including the printing head in the state where the stirring of the pigment-based ink in the ink container is continuously executed.
